(19) United States
(12) Patent Application Publication
(10) Pub. No.: US 2026/0082203 A1
(43) Pub. Date: Mar. 19, 2026

(54) ROAMING THROUGH TARGET AP WITH RANDOMIZED MEDIA ACCESS CONTROL ADDRESS

(71) Applicant: Cisco Technology, Inc., San Jose, CA (US)

(72) Inventors: Binita GUPTA, San Diego, CA (US); Brian D. HART, Sunnyvale, CA (US); Jerome HENRY, Pittsboro, NC (US)

(21) Appl. No.: 19/281,652

(22) Filed: Jul. 26, 2025

Related U.S. Application Data
(60) Provisional application No. 63/695,807, filed on Sep. 17, 2024.

(51) Int. Cl. H04W 8/08; H04W 12/037; H04W 12/0471; H04W 76/15

(52) U.S. Cl. CPC H04W 8/08; H04W 12/037; H04W 12/0471; H04W 76/15

(57) ABSTRACT

The present disclosure provides techniques for client device roaming using randomized media access control (MAC) addresses in enhanced data privacy (EDP) operation. A first access point (AP) in a seamless mobility domain (SMD) exchanges a message as part of an initial association process with a station (STA) in the same SMD, the message comprising an identifier of the STA. The first AP establishes a first pairwise transient key (PTK) with the STA, and generates a first PTK mapping that associates the first PTK with the identifier of the STA.

### CROSS-REFERENCE TO RELATED APPLICATIONS

This application claims benefit of co-pending U.S. provisional patent application Ser. No. 63/695,807 filed Sep. 17, 2024. The aforementioned related patent application is herein incorporated by reference in its entirety.

### TECHNICAL FIELD

Embodiments presented in this disclosure generally relate to wireless communication. More specifically, embodiments disclosed herein relate to facilitating secure roaming through a target access point (AP) using a randomized media access control (MAC) address.

### BACKGROUND

Seamless roaming within a Seamless Mobility Domain (SMD) has been proposed in ultra-high reliability (UHR)/TGbn for improved performance. A seamless roaming procedure involves a station (STA) transitioning from its currently associated AP to a target AP MLD. This typically occurs when the STA experiences a sudden drop in received signal strength indicator (RSSI) from its associated AP. To maintain network connectivity, the STA may perform a last-minute roam to the target AP. In an SMD, roaming is typically achieved through a shared pairwise transient key (PTK) among AP MLDs for a given STA. The shared PTK allows the serving and target AP MLDs to use the same security credentials without performing a full reauthentication process. When the STA sends a roaming request to the target AP MLD, the request is secured using protected management frames (PMF) and encrypted with the shared PTK. The target AP MLD then decrypts the request using the same PTK and therefore enables seamless execution of the roaming procedure.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts an example SMD where a roaming request includes an identifiable random MAC (IRM) address or Device ID for STA recognition by a target AP, and a shared PTK is used to facilitate seamless roaming, according to some embodiments of the present disclosure.

FIG. 1B depicts an example SMD where a roaming request includes an IRM address or Device ID for STA recognition by a target AP, and different PTKs are used for communication between each AP and the STA, according to some embodiments of the present disclosure.

FIG. 2A depicts an example SMD where a roaming request includes a distribution system (DS) MAC address for STA recognition by a target AP, and a shared PTK is used to facilitate seamless roaming, according to some embodiments of the present disclosure.

FIG. 2B depicts an example SMD where a roaming request includes a DS MAC address for STA recognition by a target AP, and different PTKs are used for communication between each AP and the STA, according to some embodiments of the present disclosure.

FIG. 3A depicts an example SMD where a serving AP shares a STA's DS MAC address, its current enhanced data privacy (EDP) random MAC (ERM) address, and a set of next ERM addresses with a target AP, and the target AP recognizes a next ERM address included in a roaming request to retrieve a shared PTK for decryption, according to some embodiments of the present disclosure.

FIG. 3B depicts an example SMD where a serving AP shares a STA's DS MAC address, its current ERM address, and a set of next ERM addresses with a target AP, and the target AP recognizes a next ERM address included in a roaming request to retrieve an AP-specific PTK for decryption, according to some embodiments of the present disclosure.

FIG. 4 depicts an example sequence of interactions between a STA and two APs, where the STA roams from one AP to another using a shared PTK, and a roaming request includes an IRM address or Device ID for STA recognition by a target AP, according to some embodiments of the present disclosure.

FIG. 5 depicts an example sequence of interactions between a STA and two APs, where the STA roams between the two APs using AP-specific PTKs, and a roaming request includes an IRM address or Device ID for STA recognition by a target AP, according to some embodiments of the present disclosure.

FIG. 6 depicts an example sequence of interactions between a STA and two APs, where the STA roams from one AP to another using a shared PTK, and a roaming request includes a DS MAC address for STA recognition by a target AP, according to some embodiments of the present disclosure.

FIG. 7 depicts an example sequence of interactions between a STA and two APs, where the STA roams between the two APs using AP-specific PTKs, and a roaming request includes a DS MAC address for STA recognition by a target AP, according to some embodiments of the present disclosure.

FIG. 8 depicts an example sequence of interactions between a STA and two APs, where the STA roams from one AP to another using a shared PTK, and a roaming request includes a next ERM address for STA recognition by a target AP, according to some embodiments of the present disclosure.

FIG. 9 depicts an example sequence of interactions between a STA and two APs, where the STA roams between the two APs using AP-specific PTKs, and a roaming request includes a next ERM address for STA recognition by a target AP, according to some embodiments of the present disclosure.

FIG. 10 depicts an example method performed by a serving AP (AP 1) during the initial association, including establishing PTKs and sharing the STA's identifier information with other APs in the same SMD, according to some embodiments of the present disclosure.

FIG. 11 depicts an example method performed by a target AP (AP 2) in response to a roaming request from a STA (STA 1), according to some embodiments of the present disclosure.

FIG. 12 depicts an example method performed by a STA (STA 1), beginning with an initial association to AP 1 and proceeding to a roaming event with AP 2, according to some embodiments of the present disclosure.

FIG. 13 is a flow diagram depicting an example method performed by a serving AP for handling an initial association from a STA and generating a PTK mapping that associates the STA's identifier with an established PTK, according to some embodiments of the present disclosure.

FIG. 14 depicts an example network device configured to perform various aspects of the present disclosure, according to some aspects of the present disclosure.

FIG. 15 depicts an example client device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including exchanging, by a first access point (AP) in a seamless mobility domain (SMD), a message as part of an initial association process with a station (STA) in the same SMD, the message comprising an identifier for the STA, establishing, by the first AP, a first pairwise transient key (PTK) with the STA, and generating, by the first AP, a first PTK mapping that associates the first PTK with the identifier for the STA.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### Example Embodiments

In a SMD, secure and efficient roaming is facilitated by sharing a PTK among multiple APs for a given STA. Specifically, the same PTK is used by both the serving AP MLD and the target AP MLD to protect and authenticate roaming requests sent by the STA. When a STA roams to a target AP, the roaming request is protected using protected management frames (PMF) and encrypted with the shared PTK. To process the roaming request, the target AP MLD needs to retrieve and use the correct PTK associated with the STA. However, the PTK may not be pre-installed at the target AP MLD. In such cases, the target AP MLD may retrieve the PTK from a centralized wireless local area network (WLAN) controller (WLC) or from a distributed key repository. Even when the target AP has access to the correct pairwise transient key security association (PTKSA), it still needs to identify the correct PTK based on information available in the MAC header of the roaming request.

One approach is for the target AP to extract the Transmitter Address (TA) from the roaming request and use it to identify the STA and retrieve the corresponding PTK. However, emerging standards such as IEEE 802.11bh and 802.11bi introduce privacy features that randomize MAC addresses before and during association. The conventional mechanism for STA recognition during roaming relies on using a stable MAC address (e.g., in the TA field) to identify the STA. However, with the adoption of randomized MAC addresses in 802.11bh/bi, the target AP can no longer rely on the TA in the roaming request to identify the STA and retrieve the correct PTK.

Embodiments of the present disclosure address this issue and other relevant concerns by providing mechanisms that allow the target AP MLD to recognize the STA, even when 802.11bh/bi randomized MAC addresses (e.g., identifiable random MAC (IRM) addresses) are in use. The disclosed mechanisms enable secure and seamless roaming within a SMD without requiring full reauthentication.

IEEE 802.11bh has defined the identifiable random MAC (IRM) address mechanism, where a STA provides an IRM to its associated AP as part of the 4-way handshake during the association process. The IRM serves as an identifier that can be shared across APs within the extended service set (ESS). Once the IRM is established, the STA can later use it as the TA when associating with another AP in the same ESS, allowing the target AP to recognize the STA and apply cached information from a previous association. In one embodiment, when a STA intends to roam from a serving AP to a target AP in the same SMD, the IRM that was previously provided to the serving AP during association may be included in the TA field of the roaming request. The target AP, upon receiving the roaming request, may recognize the STA based on the included IRM and retrieve the corresponding PTK to decrypt and process the request.

IEEE 802.11bh also defines a Device Identifier (Device ID) mechanism, where the Device ID is a unique identifier assigned by the AP to the STA during the 4-way handshake. In one embodiment, the Device ID may be included in the TA field of a roaming request and serve as a stable identifier for STA recognition by the target AP. The Device ID may be formatted as a MAC address or in any other suitable format (e.g., determined by the AP).

In embodiments where IEEE 802.11bi Enhanced Data Privacy (EDP) is used, the STA may provide a distribution system (DS) MAC address in the encrypted association request. As used herein, the DS MAC address refers to a MAC address used for communication within a distribution system (DS). The DS MAC address is associated with a STA and typically remains consistent across sessions or epochs, even when other MAC addresses (e.g., IRM) change for privacy purposes. The DS MAC address serves as a stable backend identity for the STA across basic service set (BSS) transition and EDP epoch boundaries. In one embodiment, the DS MAC address may be included in the TA field of a roaming request. Upon receiving the request, the target AP may recognize the STA based on the DS MAC address and retrieve the corresponding PTK to decrypt and process the request.

In another embodiment, the DS MAC address is not exposed over-the-air (OTA) in clear form during roaming. Instead, an EDP random MAC (ERM) address may be defined and generated specifically for the roaming event, in addition to the IRM address used for regular data communication within an epoch. The serving AP shares the DS MAC address along with the current ERM address and a set of next ERM addresses with one or more target APs. When the STA roams, the STA includes a next ERM address in the TA field of the roaming request, where the next ERM address corresponds to the current EPD epoch. The target AP may then use the address mapping (which associates the next ERM addresses with the STA's DS MAC address) to identify the STA and retrieve the correct PTK for decrypting and processing the roaming request.

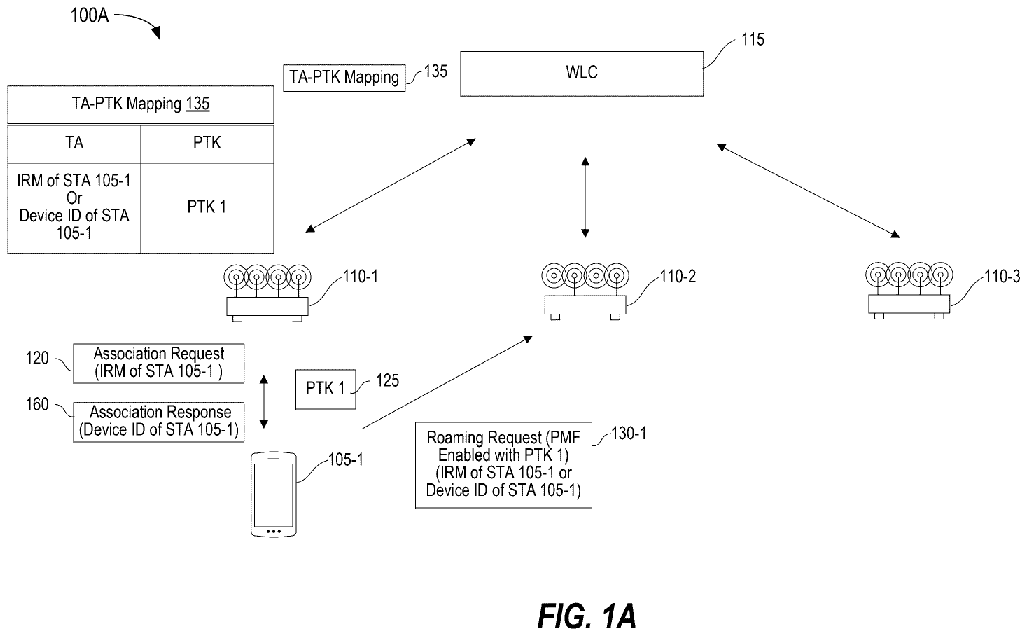

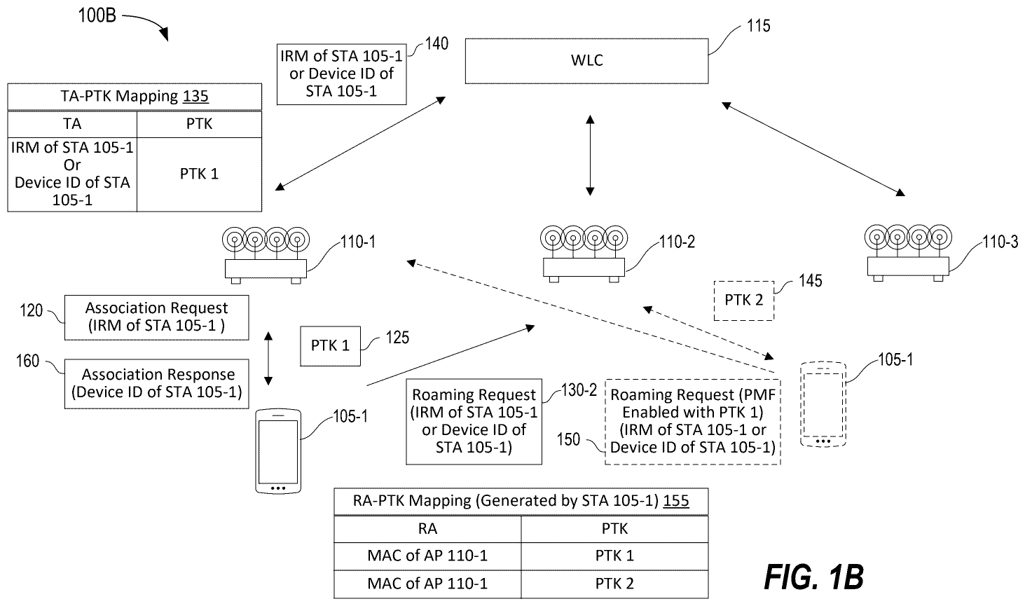

FIG. 1A depicts an example SMD 100A where a roaming request 130-1 includes an identifiable random MAC (IRM) address or Device ID for STA recognition by a target AP, and a shared PTK is used to facilitate seamless roaming, according to some embodiments of the present disclosure.

As depicted, the example SMD 100A includes three APs: AP 110-1, AP 110-2, and AP 110-3. All three APs are connected and controlled by a WLC 115. In the illustrated embodiment, IEEE 802.11bh is implemented, and a STA 105-1 provides an IRM address to AP 110-1 during the association process, such as by including the address in the association request 120 or as part of the 4-way handshake, for example, in the Extensible Authentication Protocol over Local Area Network (LAN) (EAPOL) M4 message sent by the STA to the AP. Upon completion of the handshake, a PTK 1 (125) is established between STA 105-1 and AP 110-1. As used herein, the PTK may be shared with other APs (e.g., AP 110-2 or AP 110-3) in the same SMD. When the STA 105-1 roams to another AP in the SMD, the roaming request is protected using PMF and encrypted with the shared PTK (e.g., PTK 1). The target AP may then use the same PTK to decrypt the roaming request and process it accordingly.

To allow the correct identification of the STA 105-1 and retrieval of the shared PTK (e.g., PTK 1) by a target AP, in one embodiment, the IRM address provided by STA 105-1 during association may be used as a reference identifier. The IRM may be included in the transmitter address (TA) field of a subsequent roaming request. When a target AP receives the roaming request, the target AP can recognize the STA 105-1 based on the IRM address and retrieve the correct PTK.

IEEE 802.11bh also defines a Device ID mechanism, where the Device ID is assigned by an AP MLD (e.g., 110-1) to a non-AP MLD (e.g., 105-1) during the association process. The Device ID may be provided either in the association response frame 160 or as part of the 4-way handshake, for example, in EAPOL Message 1 (M1) or a Message 3 (M3). In the example SMD 100A, the Device ID of STA 105-1 may be used as the reference identifier for PTK retrieval. The Device ID may be formatted in any manner determined by the AP 110-1. In one embodiment, the AP 110-1 may provide the Device ID in the form of a MAC address. When roaming to a target AP, the STA 105-1 may use the assigned Device ID as the TA in the roaming request.

As shown, after initial association, AP 110-1 generates a mapping 135 that associates the reference identifier (e.g., the IRM address provided by the STA 105-1 or the Device ID assigned by the AP 110-1 to the STA 105-1) with the established PTK 1 (125). The TA-PTK mapping 135 is then shared with WLC 115. In some embodiments, the WLC may proactively distribute the mapping 135 to other APs (e.g., AP 110-2 or AP 110-3) in the SMD, allowing these APs to install and store the reference identifier and shared PTK locally for future use. In some embodiments, the WLC 115 may store the mapping in a centralized database and provide it to a target AP in response to a query at the time of roaming. In some embodiments, the mapping may be shared directly between APs using protected action frames or other suitable over-the-air (OTA) management frames.

As depicted in FIG. 1A, when STA 105-1 roams from AP 110-1 to AP 110-2, the STA 105-1 sends a roaming request 130-1 to AP 110-2. As used herein, the roaming request may include a Reassociation Request frame, Link Reconfiguration Request frame, Add Link Request frame, Delete Link Request frame, or any other request that is used for performing roaming over-the-air through the target AP MLD. The roaming request 130-1 is protected using PMF and encrypted with PTK 1. The reference identifier, such as the IRM address or Device ID previously established during the 4-way handshake, is included in the TA field of the roaming request. Upon receiving the request, AP 110-2 recognizes the STA based on the IRM address or Device ID and retrieves the correct PTK 1, either from its local cache or by querying the WLC 115. With the correct PTK available, AP 110-2 decrypts the request 130-1 and completes the roaming process by authenticating and associating with STA 105-1 using the existing security context. This mechanism allows the target AP (e.g., AP 110-2) to bypass a full reauthentication process (e.g., an EAP exchange) and therefore enables a more efficient and smooth transition for STA 105-1 within the SMD.

In some embodiments, the roaming request 130-1 may further include a new reference identifier (e.g., a new IRM address) that the STA 105-1 intends to use in a subsequent roaming event. Upon receiving and processing the roaming request, AP 110-2 may update its local cache table to associate the newly provided reference identifier with the existing PTK (e.g., PTK 1). AP 110-2 may also share the updated identifier with the WLC 115. The WLC 115 may then distribute the updated mapping to other APs in the same SMD, either proactively or in response to a future query. The updated mapping (which associates the PTK 1 with the next IRM or Device ID) allows the rest of the domain to be prepared for a subsequent roaming event by the STA 105-1. When an IRM address is used as the reference identifier, the next IRM address may be included in the roaming request 130-1 sent by the STA. When a Device ID is used as the reference identifier, the next Device ID intended for a future use is generated and assigned by the AP. In this case, the AP may share the next Device ID with other APs in the SMD, either via OTA signaling (e.g., protected action frames) or through a WLC.

FIG. 1B depicts an example SMD 100B where a roaming request 130-2 includes an IRM address or Device ID for STA recognition by a target AP, and different PTKs are used for communication between each AP and the STA, according to some embodiments of the present disclosure.

In the example SMD 100B, different PTKs are used for communication between the STA 105-1 and each AP 110, instead of a shared PTK across the domain (as depicted in FIG. 1A). In this embodiment, the PTK is AP-specific (also referred to as a per-AP PTK). Each AP independently derives its own PTK with the STA 105-1 through a separate authentication exchange, and the PTK is valid only for communication between that AP and the STA. For example, PTK 1 (125) is established between STA 105-1 and AP 110-2 during their initial association. When STA 105-1 later roams to AP 110-2, PTK 1 cannot be reused. Instead, STA 105-1 and AP 110-2 perform a full EAP exchange to derive a new key, PTK 2 (145). However, when the STA subsequently roams back to an AP with which a PTK has already been established—such as returning from AP 110-2 back to AP 110-1—there is no need to repeat the full authentication process. In this configuration, PTK 1 (125) is reused to encrypt the roaming request 150. Therefore, in this embodiment, correct PTK retrieval is needed for efficient handovers. The reference identifier used for this PTK retrieval may be either the IRM address that the STA provided during the initial association process, such as within the association response 120 (or in EAPOL M2 or M4), or a Device ID assigned by the AP, such as within the association response 160 (or in EAPOL M1 or M3). After initial association, AP 110-1 generates a TA-PTK mapping 135 that associates the reference identifier (e.g., IRM or Device ID) with the locally established PTK 1 (125).

Because the PTK 1 is specific to the AP 110-1, it is not shared with the WLC 115. Instead, only the reference identifier 140 (e.g., IRM or Device ID) is shared with the WLC 115. The WLC 115 may then provide the identifier to other APs in the SMD (e.g., either proactively or in response to a query), so that the rest of the domain can recognize the STA 105-1 upon roaming. In some embodiments, the reference identifier 140 may be shared directly by AP 110-1 to others using protected action frames or other suitable over-the-air (OTA) management frames.

In addition, the STA 105-1 maintains its own RA-PTK mapping 155, which associates each established PTK with the MAC address of the corresponding AP (which is included within the Receiver Address (RA) field of a request frame). The RA-PTK mapping 155 allows the STA 105-2 to determine which PTK to use when roaming back to a known AP. As depicted in FIG. 1B, when STA 105-1 roams to AP 110-2, it first sends a roaming request 130-2 to AP 110-2. Because no PTK has yet been established between the STA 105-1 and AP 110-2, the roaming request 130-2 is unencrypted or protected using PMF with a default key (e.g., pairwise master key (PMK) established during Simultaneous Authentication of Equals (SAE)). The roaming request 130-2 also includes a reference identifier of the STA, such as the IRM or Device ID that was previously provided during the initial association process with AP 110-1. Upon receiving the roaming request 130-2 and recognizing the STA based on the included reference identifier, STA 105-1 and AP 110-2 proceed through a full EAP exchange to authenticate and establish a new PTK, referred to as PTK 2 (145). AP 110-2 then caches this PTK along with the reference identifier for future use. Later, when STA 105-1 decides to roam back to AP 110-1 (e.g., due to increased signal strength or movement back into AP 110-1's coverage), STA 105-1 retrieves PTK 1 from its local RA-PTK mapping 155, using the MAC address of AP 110-1 as the lookup key. STA 105-1 then encrypts the roaming request 150 using PTK 1 (125) and includes the previously assigned reference identifier (e.g., IRM or Device ID) in the TA field of the request 150. Upon receiving the request 150, AP 110-1 recognizes the STA 105-1 based on the included identifier, retrieves PTK 1 from its local cache, and decrypts the roaming request 150. The roaming process from AP 110-2 to AP 110-1 is completed without requiring a new EAP exchange, facilitating an efficient and secure handover using the previously established security context.

The Device ID, as defined in IEEE 802.11bh, is an identifier assigned by an AP MLD to a non-AP MLD as part of the 4-way handshake during the association process. In the disclosed embodiment, the AP 110-1 may provide the Device ID in the form of a MAC address and use it as a reference identifier in subsequent roaming requests.

The roaming requests 130-1, 130-2, and 150 discussed herein may include, for example, a Reassociation Request frame, Link Reconfiguration Request frame, Add Link Request frame, Delete Link Request frame, or other OTA management frame used to facilitate handover through a target AP.

In some embodiments, the roaming requests 130-2 and 150 may include a next reference identifier that the STA 105-1 intends to use for a future roaming event to identify itself, such as a next IRM or a new Device ID. Upon receiving the next identifier, in one embodiment, the target AP may update its local mapping and share the identifier with the WLC 115. The WLC 115 may then send the updated identifier to other APs in the SMD (e.g., either proactively or in response to queries) so that those APs are prepared to recognize the STA 105-1 when the next roaming event occurs. In other embodiments, the target AP may communicate the address information directly to other APs using protected action frames or other suitable management frames. In cases where an IRM address is used as the reference identifier, the next IRM address may be included in the roaming request 130-1 sent by the STA. In cases where a Device ID is used as the reference identifier, the next Device ID intended for a future use is generated and assigned by the AP. In this case, the AP may share the next Device ID with other APs in the SMD, either via OTA signaling (e.g., protected action frames) or through a WLC.

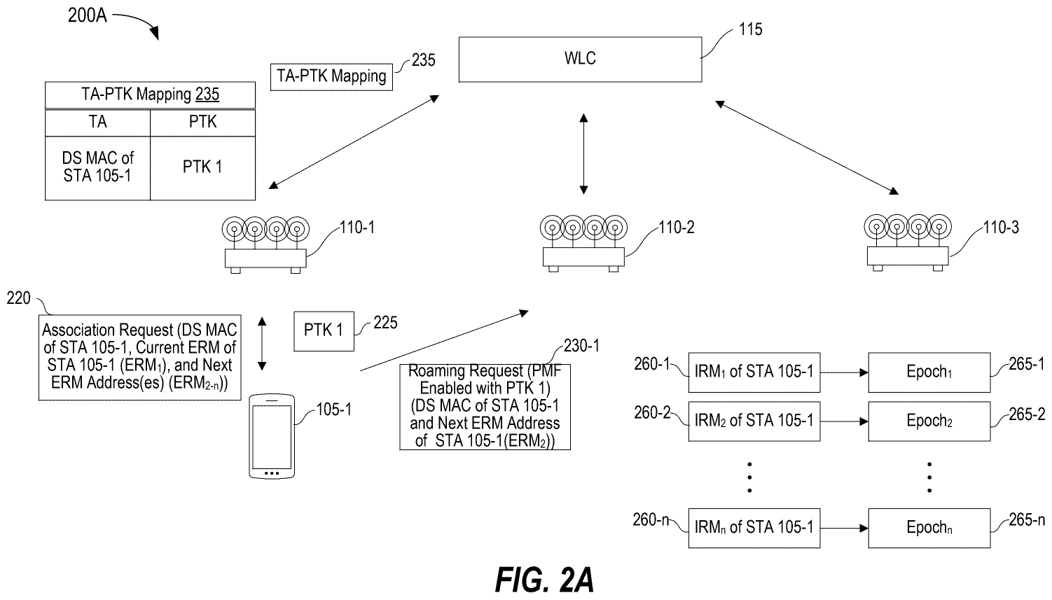

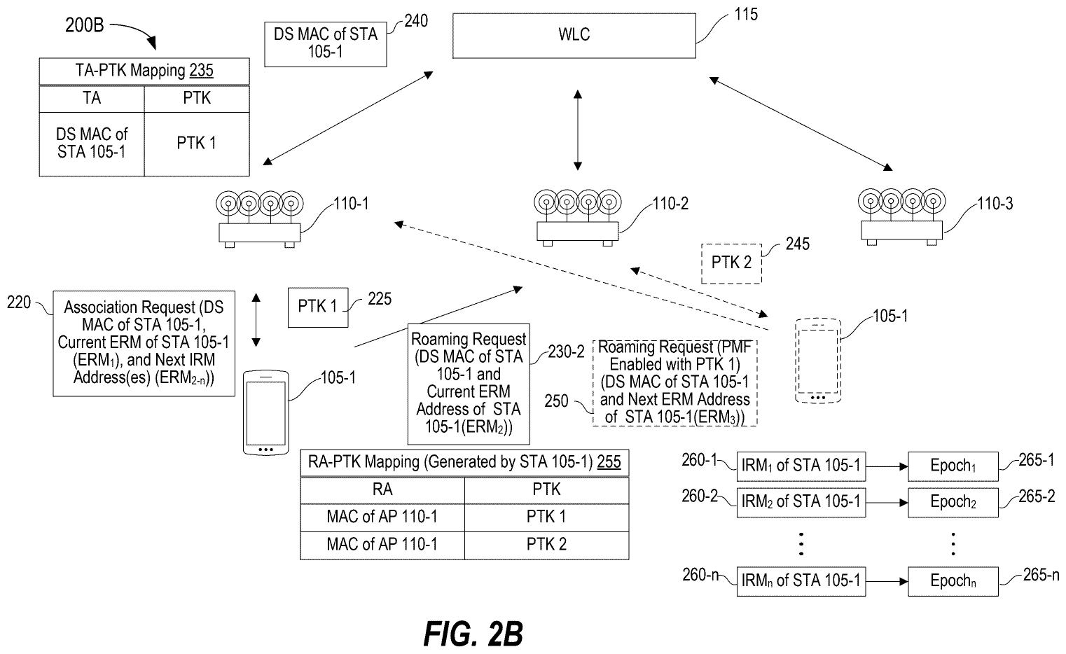

FIG. 2A depicts an example SMD 200A where a roaming request 230-1 includes a distribution system (DS) MAC address for STA recognition by a target AP, and a shared PTK is used to facilitate seamless roaming, according to some embodiments of the present disclosure.

As depicted, the example SMD 200A includes three APs: AP 110-1, AP 110-2, and AP 110-3. All three APs are connected and controlled by a WLC 115. In the example SMD 200A, IEEE 802.11bi EDP is implemented, where the STA's OTA MAC address is periodically randomized across epoch boundaries to improve user privacy. More specifically, the IRM address used by the STA changes for each epoch. As depicted, IRM₁ (260-1) is used for epoch 1 (265-1), IRM₂ (260-2) is used for epoch 2 (265-2), and so on, until IRMₙ is used for epoch n (265-n). The duration of each epoch may vary and is typically determined based on device configuration and privacy policy requirements. The dynamic rotation of IRM addresses effectively prevents long-term tracking of the device by external entities based on the MAC-layer identifiers.

To support secure authentication across roaming events and maintain consistent device recognition, the STA defines an address specific for roaming recognition. Specifically, the IRM address is used for regular data communication within an epoch, and an EDP random MAC (ERM) address is generated specifically for roaming recognition. A DS MAC is also assigned to each STA 105 that remains constant across EDP epochs and BSS transitions.

During the initial association, as depicted, STA 105-1 provides to AP 110-1 its DS MAC address, the current ERM address (e.g., ERM₁) (used specifically for roaming during the current epoch), and a list of the next ERM addresses (e.g., ERM₂₋ₙ) that the STA intends to use in upcoming epochs. These addresses may be included in the encrypted portion of the Association Request frame 220 (e.g., as defined in IEEE 802.11bi EDP) or transmitted as part of the 4-way handshake within a protected EAPOL message (e.g., EAPOL M2 or M4, sent from the STA 105-1 to the AP 110-1) (not shown). The DS MAC address is a stable identifier that is used internally by the distribution system and does not change across roaming events or epoch boundaries. In this embodiment, the DS MAC address serves as a reference identifier for PTK retrieval.

As illustrated, after receiving the association request 220, AP 110-1 and STA 105-1 complete a full authentication handshake (e.g., EAPOL 4-way handshake) during which both entities establish a shared PTK, also referred to as PTK 1 (225). The PTK 1 is shared within the SMD and can be used by other APs in the domain to securely communicate with STA 105-1 without requiring a full reauthentication process.

As depicted, after initial association, AP 110-1 generates a TA-PTK mapping 235 that associates the DS MAC address of STA 105-1 with PTK 1. AP 110-1 then shares this mapping with the WLC 115, which may either proactively distribute the mapping to other APs in the domain or respond to queries when a roaming event occurs. In some embodiments, AP 110-1 may share the mapping directly with other APs using protected action frames or other OTA management frames.

When STA 105-1 roams to AP 110-2, STA 105-1 includes its DS MAC address and one of the next ERM addresses (e.g., ERM₂) in the TA field of the roaming request 230-1. AP 110-2 uses the received DS MAC address to directly identify the STA and retrieve the associated PTK 1, either from its local cache (if the mapping was proactively installed) or by querying the WLC 115. AP 110-2 then uses PTK 1 to decrypt the PMF-protected roaming request, recognize the STA, and complete the roaming process without requiring a new EAP exchange. The disclosed embodiment enables secure and seamless mobility for the STA 105-1 within the SMD 200A, even under MAC address randomization enforced by IEEE 802.11bi EDP.

FIG. 2B depicts an example SMD 200B where a roaming request 230-2 includes a DS MAC address for STA recognition by a target AP, and different PTKs are used for communication between each AP and the STA, according to some embodiments of the present disclosure.

In the example SMD 200B, IEEE 802.11bi EDP is implemented, and ERM addresses generated specifically for roaming recognition are applied across epochs. However, unlike FIG. 2A, where a shared PTK is used across APs in the same SMD, FIG. 2B depicts a scenario where AP-specific PTKs are used. In this configuration, each AP 110 independently establishes a PTK with the STA 105-1, and the PTK cannot be reused or shared with other APs.

Following the initial association between STA 105-1 and AP 110-1, a full authentication exchange (e.g., EAPOL 4-way handshake) is completed, and PTK 1 (225) is derived. AP 110-1 generates a TA-PTK mapping 235 that associates the STA's DS MAC address—provided in the association request 220 and used as the reference identifier—with PTK 1, and saves the mapping 235 in its local cache for future use. Because PTK 1 is AP-specific, it is not shared with other APs 110 or the WLC 115. Instead, the reference identifier 240 (e.g., the DS MAC address of STA 105-1) is shared with the WLC 115 or communicated directly to other APs in the SMD, allowing them to recognize the STA 105-1 in future roaming events.

With the established PTK 1, as depicted, STA 105-1 also generates a RA-PTK mapping 255, associating PTK 1 with the MAC address of the AP 110-1. With this mapping 255, STA 105-1 may quickly select the correct PTK to use when roaming back to a previously visited AP.

As illustrated, when STA 105-1 roams to AP 110-2, it sends a roaming request 230-2 to the target AP. Since PTK 1 is not shared and cannot be used for encryption at AP 110-2, the roaming request 230-2 is unencrypted or partially protected using a default key. The roaming request 230-2 includes the STA's 105-1 DS MAC address as the reference identifier and one of the next ERM addresses (e.g., ERM₂). Upon receiving the request 230-2, AP 110-2 recognizes the STA 105-1 based on the DS MAC address and proceeds with a full EAPOL authentication exchange to derive a new PTK, referred to as PTK 2 (245). AP 110-2 saves PTK 2 locally, and STA 105-1 updates its RA-PTK mapping 255 to include PTK 2 for future use.

Later, as depicted, STA 105-1 decides to roam back to AP 110-1, potentially due to increased signal strength or the STA's 105-1 movement bringing it back into the coverage area of AP 110-1. STA 105-1 retrieves PTK 1 from its local RA-PTK mapping 255 and encrypts the roaming request 250 using PTK 1. The request 250 again includes the DS MAC address and one of the next ERM addresses (e.g., ERM₃) in the TA field. Upon receiving the request 250, AP 110-1 recognizes the STA 105-1 based on the provided DS MAC address, retrieves PTK 1 from its local cache, and decrypts the request 250. With the established PTK in place, the AP 110-1 completes the handover without requiring a new EAPOL exchange.

The roaming requests 230-1, 230-2, and 250 discussed herein may include, for example, a Reassociation Request frame, a Link Reconfiguration Request frame, an Add Link Request frame, a Delete Link Request frame, or other OTA management frames used to facilitate handover through a target AP.

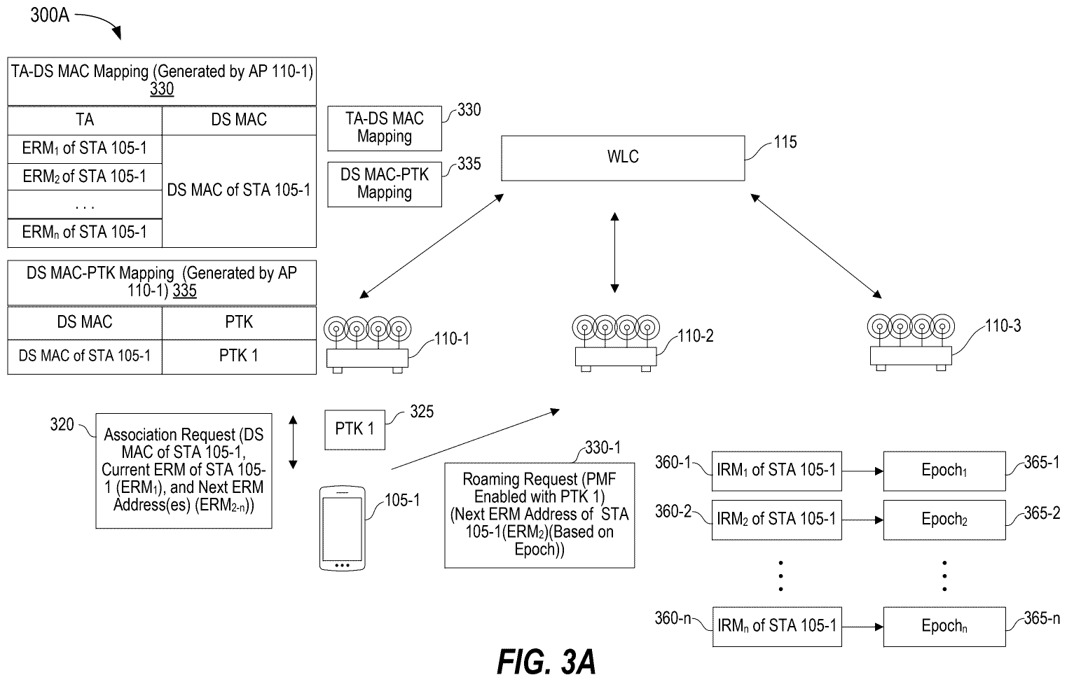

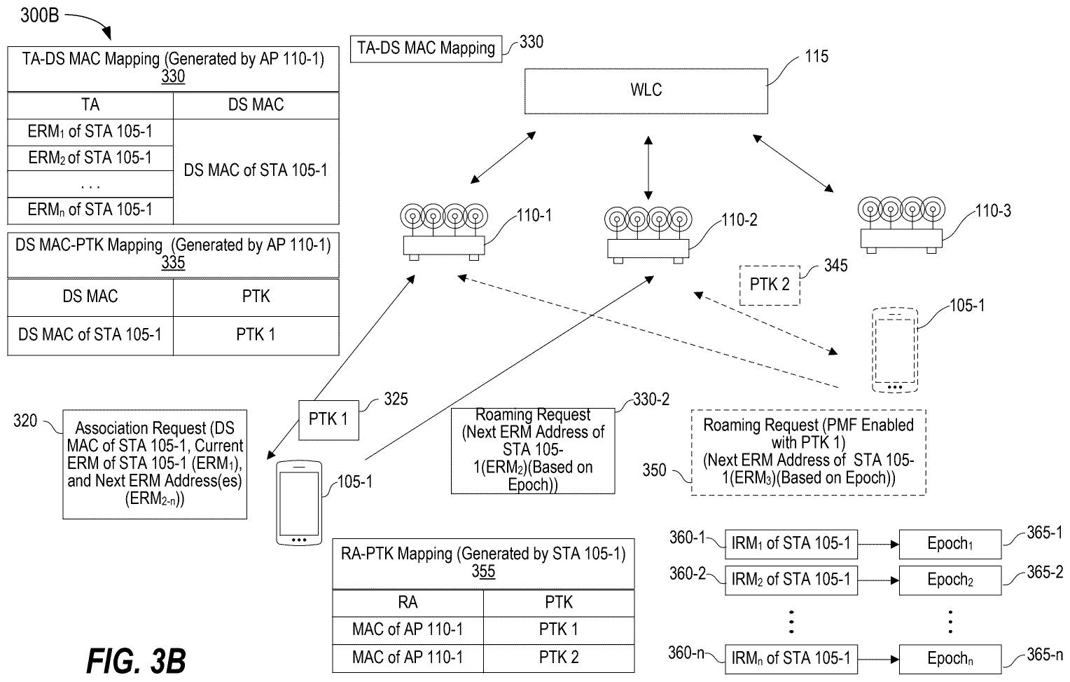

FIG. 3A depicts an example SMD 300A where a serving AP 110-1 shares a STA's 105-1 DS MAC address, its current ERM address, and a set of next ERM addresses with a target AP 110-2, and the target AP 110-2 recognizes a next ERM included in a roaming request to retrieve a shared PTK for decryption, according to some embodiments of the present disclosure.

As depicted, the example SMD 300A includes three APs: AP 110-1, AP 110-2, and AP 110-3. All three APs are connected and controlled by a WLC 115. IEEE 802.11bi EDP is enforced in the example SMD 300A, and randomized MAC addresses are applied across epoch boundaries. For example, IRM₁ (360-1) is used for epoch 1 (365-1), IRM₂ (360-2) is used for epoch 2 (365-2), and so on, until IRMₙ (360-n) is used for epoch n (365-n). To improve privacy and reduce over-the-air exposure of persistent identifiers, the STA 105-1 uses a distinct ERM address for roaming recognition (separate from the IRM used for regular data communication within an epoch).

Unlike the embodiments shown in FIGS. 2A and 2B, where the DS MAC address is included in the cleartext in the roaming request, this embodiment avoids exposing the DS MAC address over the air, improving privacy and reducing the risk of persistent tracking by attackers. To achieve this, the STA 105-1 uses one of its pre-assigned next ERM addresses as a reference identifier in the roaming request, instead of sending the DS MAC address directly.

As depicted, during the initial association process, STA 105-1 provides its DS MAC address, the current ERM address (e.g., ERM₁) (used for roaming during the current epoch), and a list of next ERM addresses (e.g., ERM₂₋ₙ) to AP 110-1. The information may be provided either in the encrypted portion of the Association Request frame 320 (e.g., as defined in IEEE 802.11bi EDP) or as part of the 4-way handshake, such as within EAPOL M2 or M4 sent from STA 105-1 to AP 110-1. Upon receiving this information, AP 110-1 generates two mappings: a TA-DS MAC mapping 330, which associates each ERM address (e.g., the current and next ERM addresses) with the STA's DS MAC address, and a DS MAC-PTK mapping, which associates the DS MAC address with the established shared PTK 1. These mappings may then be shared with the WLC 115, which can either proactively distribute them to other APs in the SMD or respond to mapping queries from target APs. In some embodiments, AP 110-1 may share the mappings directly with other APs using protected action frames or other suitable OTA management frames.

As illustrated, when STA 105-1 roams to AP 110-2, STA 105-1 includes one of its next ERM addresses (e.g., ERM₂) in the TA field of the roaming request 330-1. The roaming request is secured using PMF and encrypted with the shared PTK 1. AP 110-2 uses the received ERM address to look up the corresponding DS MAC address using the TA-DS MAC mapping 330, and then retrieves PTK 1 from the DS MAC-PTK mapping 335. With PTK 1 retrieved, AP 110-2 decrypts the PMF-protected roaming request 330-1 and completes the handover without going through a new EAP exchange.

Compared with the embodiment depicted in FIG. 2A, the method illustrated in FIG. 3A provides improved privacy by avoiding exposure of the DS MAC address over the air. In this embodiment, the STA 105-1 uses the next ERM address, which is randomized per EDP epoch for roaming purpose, as the reference identifier in the roaming request. As the ERM address is periodically refreshed and is not linked across epochs, this approach prevents tracking of the STA 105-1 based on a static identifier over time.

FIG. 3B depicts an example SMD 300B where a serving AP 110-1 shares a STA's 105-1 DS MAC address, its current ERM address, and a set of next ERM addresses with a target AP 110-2, and the target AP 110-2 recognizes a next ERM included in a roaming request to retrieve an AP-specific PTK for decryption, according to some embodiments of the present disclosure.

In the example 300B, MAC address randomization as defined in IEEE 802.11bi is enforced. In this configuration, the STA 105-1 uses IRM addresses for regular communication and ERM addresses for roaming. The DS MAC address is used internally by the network for STA recognition but is not included in cleartext in roaming requests to avoid exposing a persistent identifier over the air.

Unlike the embodiment shown in FIG. 3A, where a shared PTK is used across APs, the embodiment in FIG. 3B applies an AP-specific PTK mechanism. In this mechanism, each AP 110 independently establishes its own PTK with the STA, and these PTKs cannot be reused by other APs 110 within the SMD 300B.

As depicted, during the initial association between STA 105-1 and AP 110-1, the STA 105-1 provides its DS MAC address, the current ERM address (e.g., ERM₁), and a list of the next ERM addresses (e.g., ERM₂₋ₙ) that STA 105-1 intends to use in future roaming events. This information may be provided either in the encrypted portion of the association request 320 (e.g., as defined in IEEE 802.11bi EDP) or within a protected EAPOL message (e.g., M2 or M4) (not shown). Based on the information, AP 110 generates two mappings: a TA-DS MAC mapping 330, which associates the current and next ERM addresses to the STA's DS MAC address, and a DS MAC-PTK mapping 335, which associates the DS MAC address with the newly established PTK 1. Because the PTK is AP-specific, only the TA-DS MAC mapping 330 is shared with the WLC 115 or distributed directly to other APs in the SMD. The sharing allows other APs in the domain to recognize the STA 105-1 based on its next ERM addresses and retrieve the corresponding PTK for decryption and device handover.

As illustrated, when STA 105-1 roams to AP 110-2, it sends a roaming request 330-2 to the target AP. The roaming request 330-2 is either unencrypted or protected with a default PMK key, as no PTK exists yet between the STA a105-1 and AP 110-2. The request 330-2 includes one of the next ERM addresses (e.g., ERM₂), in the TA field of the roaming request 330-2. As no PTK exists yet between STA 105-1 and AP 110-2, a full EAPOL 4-way handshake is performed to establish a new PTK 2 (345). PTK 2 (345) may be cached locally at AP 110-2 for future use.

Later, when STA 105-1 decides to roam back to AP 110-1 (e.g., due to increased signal strength or movement back into AP 110-1's coverage), STA 105-1 retrieves PTK 1 from its local RA-PTK mapping 355, uses it to encrypt a new roaming request 350, and includes another next ERM address (e.g., ERM₃) in the TA field. Upon receiving the request 350, AP 110-1 uses the ERM address to retrieve the corresponding DS MAC address from its TA-DS MAC mapping, then looks up PTK 1 using the DS MAC. With PTK 1 retrieved, AP 110-1 decrypts the roaming request 350 and completes the handover without requiring a new EAP exchange.

The use of ERM₂ in the roaming request 330-2 to AP 110-2, and ERM₃ in the subsequent roaming request 350 to AP 110-1, is provided for conceptual clarity. In some embodiments, the ERM address included in a roaming request corresponds to the EDP epoch in effect at the time of roaming. If the STA's pool of next ERM addresses has expired or been exhausted, the STA 105-1 may provide a new set of ERM addresses in the roaming request or in another suitable management or action frame sent to the target AP. The target AP may then update its local TA-DS MAC mapping and share the updated mapping with other APs in the SMD (e.g., either directly or through the WLC 115), to maintain backend recognition and support future roaming events.

In some embodiments, the generation of next ERM addresses is based on a shared key and algorithm known to both the STA and target AP. In such configurations, instead of explicitly transmitting new ERM addresses, the STA may send a signal or indication requesting the target AP to generate a new set of ERM addresses locally using the shared key. In another embodiment, the target AP may initiate ERM address regeneration upon detecting that the previously shared list has been exhausted or has expired.

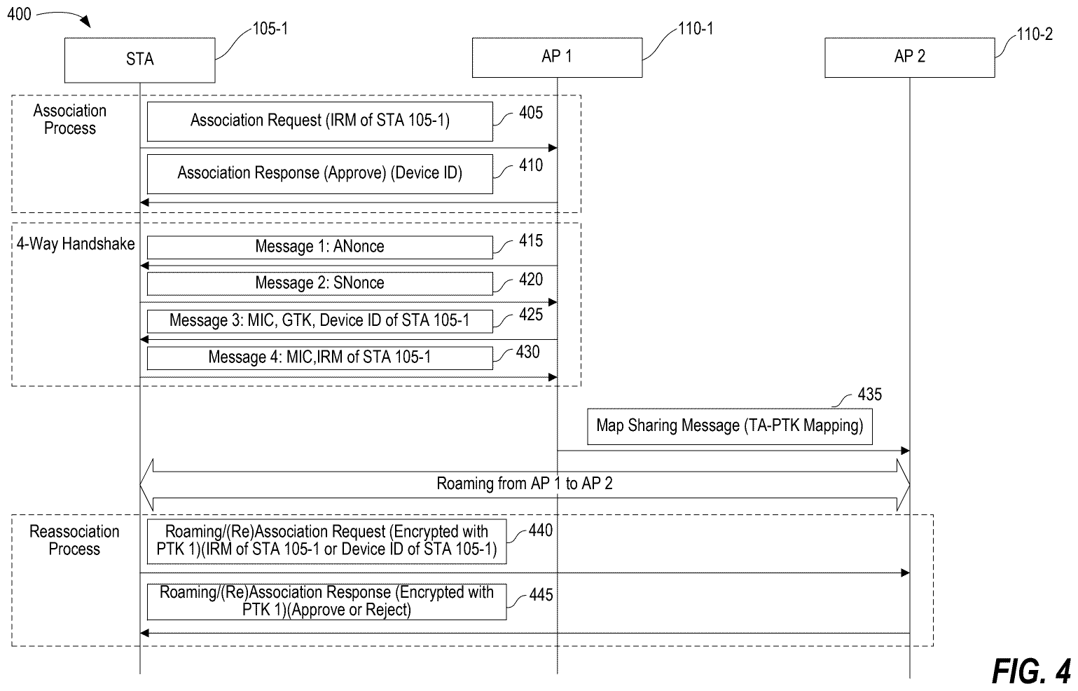

FIG. 4 depicts an example sequence of interactions 400 between a STA 105-1 and two APs 110-1 and 110-2, where the STA 105-1 roams from one AP to another using a shared PTK, and a roaming request includes an IRM address or Device ID for STA recognition by a target AP, according to some embodiments of the present disclosure.

The STA 105-1 corresponds to the STA 105-1 as depicted in FIG. 1A. The AP 110-1 and AP 110-2 correspond to the AP 110-1 and AP 110-2 as depicted in FIG. 1A, respectively. AP 110-1 and AP 110-2 belong to the same SMD and are controlled by a backend infrastructure (e.g., WLC 115 of FIG. 1A).

In this embodiment, IEEE 802.11bh is enforced, where the IRM is provided by the STA 105-1 during the initial association process, such as in the association request (or in EAPOL M2 or M4), and a Device ID is assigned by the AP 110-1 to STA 105-1, such as in the association response (or in EAPOL M1 or M3). Either the IRM or the Device ID may serve as the reference identifier for PTK retrieval and subsequent roaming requests.

As depicted, the initial association process begins with STA 105-1 sending an association request 405 to AP 110-1. The association request may include an IRM address, as defined under the IEEE 802.11bh framework. Upon receiving the request, AP 110-1 evaluates the association conditions and responds with either an acceptance or rejection. If the association is accepted, as depicted, AP 110-1 may assign a Device ID to the STA 105-1 and provide it in the association response frame 410. Following successful association, the AP 110-1 initiates the 4-way handshake to establish PTK 1. The handshake involves four message exchanges: EAPOL M1 (415), which is sent from the AP 110-1 to STA 105-1 and includes an ANonce for PTK derivation; EAPOL M2 (420), sent from STA 105-1 to AP 110-1, including an SNonce used in key derivation; EAPOL M3 (425), which is sent from the AP 110-1 to STA 105-1 and includes a Message Integrity Code (MIC) confirming integrity of the PTK and the Group Temporary Key (GTK) if group key distribution is needed; and EAPOL M4 (430), which is sent from the STA 105-1 to AP 110-1 and includes a MIC confirming successful PTK installation.

In some embodiments, STA 105-1 may provide the IRM address as part of the 4-way handshake during the initial association, such as in EAPOL M2 (420) or M4 (430) (e.g., encrypted using the established PTK). In some embodiments, the AP 110-1 may assign the Device ID to the STA 105-1 and provide it as part of the 4-way handshake, such as in EAPOL M1 (415) or M3 (425).

Following the completion of the handshake, PTK 1 is established. AP 110-1 generates a mapping that associates PTK 1 with the appropriate reference identifier (e.g., either the IRM address in M2 or M4 or the Device ID in M1 or M3). The mapping is then shared with other APs in the SMD, either directly or via a WLC (e.g., 115 of FIG. 1A), as depicted by the map sharing message 435.

As depicted, when STA 105-1 roams to AP 110-2, STA 105-1 sends a roaming request 440 protected using PTK 1 under the PMF framework. The roaming request 440 includes the same reference identifier (IRM or Device ID) in the TA field. AP 110-2 uses the identifier to recognize STA 105-1, retrieve PTK 1, and decrypt the roaming request 440. If all roaming conditions are satisfied (e.g., resources are available for admission, authorization policies have been met), AP 110-2 completes the handover and responds with an acceptance in the association response 445. Otherwise, AP 110-2 rejects the roaming request.

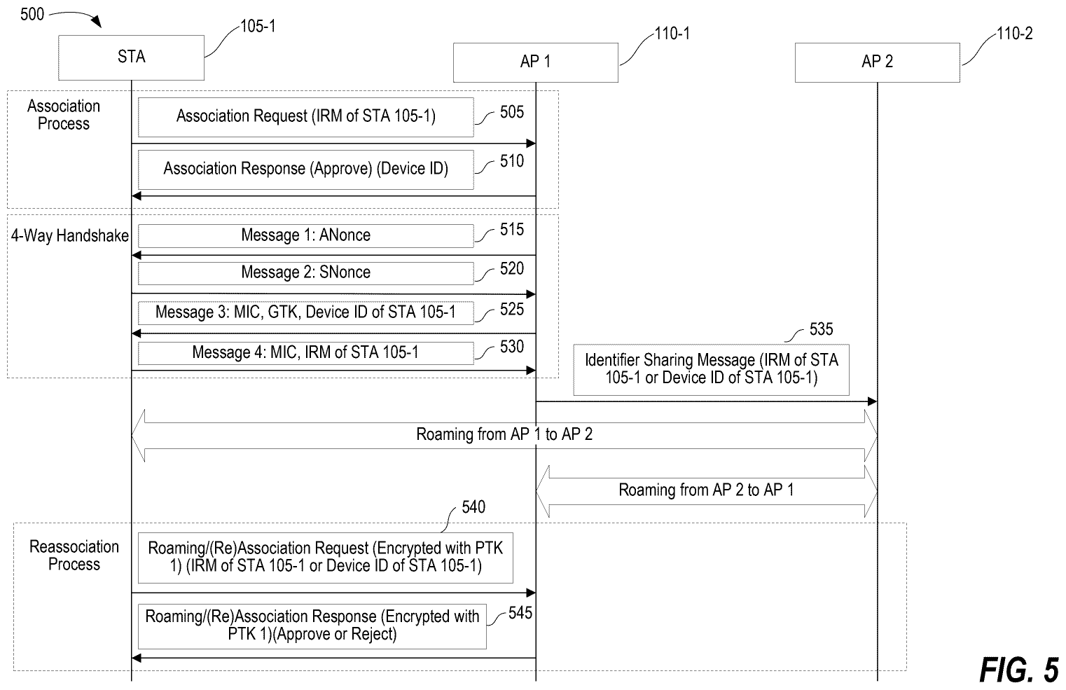

FIG. 5 depicts an example sequence of interactions 500 between a STA 105-1 and two APs 110-1 and 110-2, where the STA 105-1 roams between the two APs using AP-specific PTKs, and a roaming request includes an IRM address or Device ID for STA recognition by a target AP, according to some embodiments of the present disclosure.

The STA 105-1 corresponds to the STA 105-1 as depicted in FIG. 1B. The AP 110-1 and AP 110-2 correspond to the AP 110-1 and AP 110-2 as depicted in FIG. 1B, respectively. AP 110-1 and AP 110-2 belong to the same SMD and are controlled by a backend infrastructure (e.g., WLC 115 of FIG. 1B).

In this embodiment, IEEE 802.11bh is enforced, where the IRM is provided by the STA 105-1 during the initial association, such as in the association request 505 or in EAPOL M2 (520) or M4 (530), and a Device ID is assigned by the AP 110-1 to STA 105-1 and included either in the association response 510 or in EAPOL M1 (515) or M3 (525). Either the IRM or the Device ID may serve as the reference identifier for PTK retrieval and subsequent roaming requests. Additionally, in the example SMD, AP-specific PTKs are used (e.g., each AP 110 independently establishes its own PTK with the STA 105-1).

As depicted, STA 105-1 initiates an association with AP 110-1 by sending an association request 505 to the target AP. Upon accepting the request, AP 110-1 responds with an association response 510 with either an acceptance or rejection. If the association is accepted, the 4-way handshake is initiated to derive PTK 1. The message exchanged during the 4-way handshake includes: M1 (515), sent from AP 110-1 to STA 105-1, including an ANonce for PTK derivation; M2 (520), sent from STA 105-1 to AP 110-1, which includes an SNonce; M3 (525), sent from AP 110-1 to STA 105-1, which includes a MIC, a GTK (if applicable), and, in some embodiments, may also carry the assigned Device ID; and M4 (530), sent from STA 105-1 to AP 110-1, including a MIC confirming successful PTK installation, and, in some embodiments, may also carry the IRM address of STA 105-1.

After PTK 1 is established, AP 110-1 generates a mapping that associates PTK 1 with the reference identifier (e.g., the IRM or Device ID). Since the PTK is AP-specific, it is not shared with other APs. The reference identifier is then shared with other APs in the same SMD to enable recognition of the STA 105-1 in future roaming events. The identifier sharing step is represented by message 535, which may involve direct inter-AP communication or indirect propagation through a WLC (e.g., 115 of FIG. 1B).

At a later time, STA 105-1 roams back to AP 110-1 after connecting to AP 110-2. As depicted, the STA 105-1 sends a roaming request 540 to AP 110-1. The roaming request is encrypted using PTK 1 and includes the previously assigned IRM or Device ID in the TA field. AP 110-1 recognizes STA 105-1 based on the reference identifier (e.g., IRM or Device ID), retrieves PTK 1 from its local cache, and decrypts the request. AP 110-1 then completes the handover by sending a roaming response 545 to STA 105-1. If all roaming conditions are satisfied (e.g., AP 110-1 has sufficient resources and all policy requirements are met), the response 545 approves the request, confirming successful reassociation. Otherwise, the response 545 rejects the request, and the STA may attempt roaming again later.

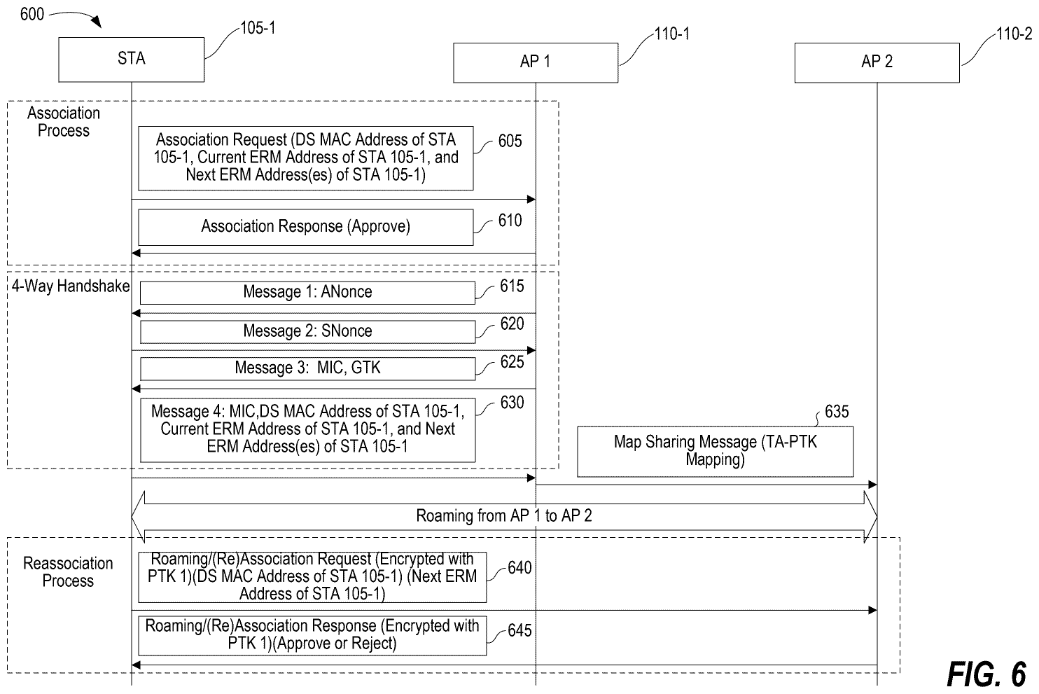

FIG. 6 depicts an example sequence of interactions 600 between a STA 105-1 and two APs 110-1 and 110-2, where the STA 105-1 roams from one AP to another using a shared PTK, and a roaming request includes a DS MAC address for STA recognition by a target AP, according to some embodiments of the present disclosure.

The STA 105-1 corresponds to the STA 105-1 as depicted in FIG. 2A. The AP 110-1 and AP 110-2 correspond to the AP 110-1 and AP 110-2 as depicted in FIG. 2A, respectively. AP 110-1 and AP 110-2 belong to the same SMD and are controlled by a backend infrastructure (e.g., WLC 115 of FIG. 2A).

In this embodiment, IEEE 802.11bi EDP is implemented, and a shared PTK is used among APs in the same SMD. Since IRM addresses change across epochs under 802.11bi EDP, the IRM can no longer serve as a stable identifier for backend STA recognition across roaming events. Instead, in this embodiment, the DS MAC address is used as the reference identifier for PTK retrieval, and an ERM address is specifically defined and used for roaming purpose.

In the IEEE 802.11bi EDP framework, STA 105-1 may provide its DS MAC address, the current ERM, and a list of next ERM addresses either in the encrypted portion of the association request 605 or as part of the 4-way handshake exchange (e.g., within EAPOL M2 or M4). As depicted, STA 105-1 initiates an association with AP 110-1 by sending an association request 605 to the target AP. The association request 605 may be encrypted (e.g., using a PMK) and include the STA's 105-1 DS MAC address, current ERM address, and a list of next ERM addresses. AP 110-1 evaluates the request and sends an association response 610 that either approves or rejects the association. Upon accepting the association, indicated by sending an association response 610, AP 110-1 initiates the 4-way handshake process, including: M1 (615), sent from AP 110-1 to STA 105-1, including an ANonce; M2 (620), sent from STA 105-1 to AP 110-1, which includes a SNonce; M3 (625), sent from AP 110-1 to STA 105-1, including key confirmation elements like the MIC and optionally the GTK; and M4 (630), sent from STA 105-1 to AP 110-1, which includes a MIC that confirms successful PTK installation, and, in some embodiments, may also carry the DS MAC address, current ERM, and a list of next ERMA addresses.

After the handshake completes, AP 110-1 generates a mapping that associates PTK 1 with the DS MAC address of STA 105-1. The mapping is then shared with other APs in the domain, either directly or via the WLC, as depicted by the map sharing message 635.

When STA 105-1 roams to AP 110-2, STA 105-1 sends a roaming request 640 to the target AP. The roaming request is encrypted using PTK 1 and includes the DS MAC address as the reference identifier and one of the next ERM addresses (e.g., ERM₂) in the TA field, corresponding to the current EDP epoch. AP 110-2 recognizes the STA 105-1 based on the included identifier, retrieves PTK 1, and decrypts the roaming request 640. AP 110-2 then completes device verification using the established PTK 1, and if all roaming conditions are satisfied (e.g., resource availability, policy compliance), AP 110-2 sends a roaming response 645 to approve the handover. Otherwise, the response 645 may reject the roaming attempt, and the STA may retry later.

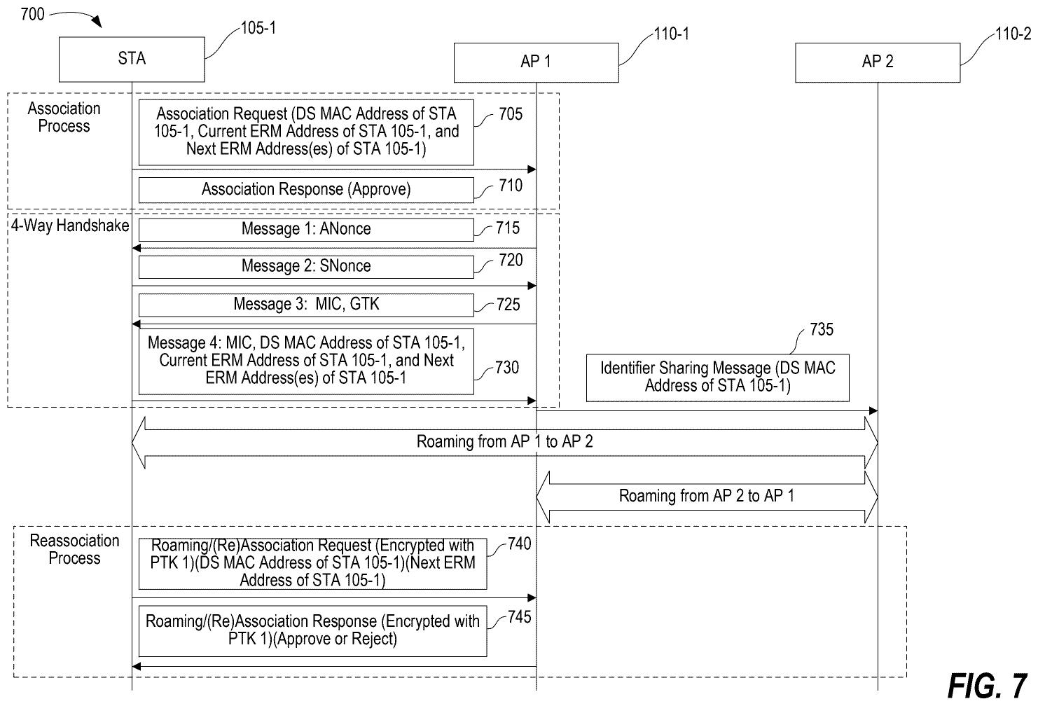

FIG. 7 depicts an example sequence of interactions 700 between a STA 105-1 and two APs 110-1 and 110-2, where the STA 105-1 roams between the two APs using AP-specific PTKs, and a roaming request includes a DS MAC address for STA recognition by a target AP, according to some embodiments of the present disclosure.

The STA 105-1 corresponds to the STA 105-1 as depicted in FIG. 2B. The AP 110-1 and AP 110-2 correspond to the AP 110-1 and AP 110-2 as depicted in FIG. 2B, respectively. AP 110-1 and AP 110-2 belong to the same SMD and are controlled by a backend infrastructure (e.g., WLC 115 of FIG. 2B).

In this embodiment, IEEE 802.11bi EDP is enforced, and the DS MAC address of a STA is served as the reference identifier for PTK retrieval and subsequent roaming requests. Additionally, in the example SMD, AP-specific PTKs are used (e.g., each AP 110 independently establishes its own PTK with the STA 105-1).

In the IEEE 802.11bi EDP framework, STA 105-1 may provide its DS MAC address, the current ERM, and a list of next ERM addresses either in the encrypted portion of the association request 705 or as part of the 4-way handshake, such as within EAPOL M2 (720) or M4 (730).

As depicted, the initial association process begins with STA 105-1 sending an association request 705 to AP 110-1. The association request 705 may be encrypted (e.g., using a PMK) and include the STA's 105-1 DS MAC address, its current ERM address, and a list of next ERM addresses. AP 110-1 evaluates the request and replies with an association response 710. Upon accepting the association, the two entities proceed with the 4-way handshake, including: M1 (715), sent from AP 110-1 to STA 105-1, including an ANonce; M2 (720), sent from STA 105-1 to AP 110-1, which includes a SNonce; M3 (725), sent from AP 110-1 to STA 105-1, including a MIC and optionally the GTK; and M4 (730), sent from STA 105-1 to AP 110-1, which includes a MIC that confirms successful PTK installation, and, in some embodiments, may also carry the DS MAC address, the current ERM, and a list of next ERM addresses.

After successful completion of the handshake, PTK 1 is established between STA 105-1 and AP 110-2. Because this is an AP-specific PTK, it is not shared with other APs. In this embodiment, AP 110-1 generates a mapping that associates the DS MAC address with PTK 1, and only the identifier information (e.g., the DS MAC) is shared with other APs in the SMD, as represented by the identifier sharing message 735.

Later, STA 105-1 connects to AP 110-2, where a new PTK (e.g., PTK 2) is established through a full 4-way handshake. At a subsequent time, as depicted, STA 105-1 decides to roam back to AP 110-1, potentially due to increased RSSI or movement back into AP's 110-1 coverage. To initiate the handover, STA 105-1 sends a roaming request 740 to AP 110-1. The request is encrypted using PTK 1 and includes the DS MAC address and one of the next ERM addresses (e.g., ERM2) in the TA field. Upon receiving the request, AP 110-1 recognizes STA 105-1 based on the DS MAC address, retrieves PTK 1 from its local cache, and decrypts the request 740. With the retrieved PTK 1, AP 110-1 verifies the integrity of the request and evaluates roaming conditions. Upon successful verification and confirmation that all roaming criteria are met (e.g., resource availability, policy compliance), AP 110-1 sends a roaming response 745 back to STA 105-1 to complete the handover.

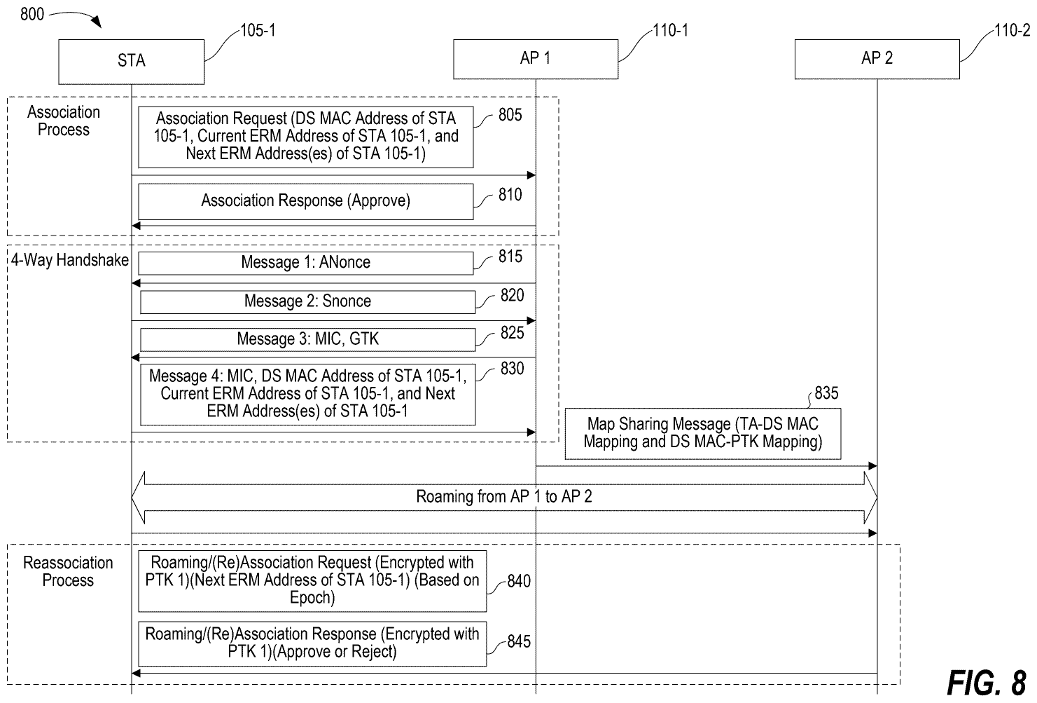

FIG. 8 depicts an example sequence of interactions 800 between a STA 105-1 and two APs 110-1 and 110-2, where the STA 105-1 roams from one AP to another using a shared PTK, and a roaming request includes a next IRM address for STA recognition by a target AP, according to some embodiments of the present disclosure.

The STA 105-1 corresponds to the STA 105-1 as depicted in FIG. 3A. The AP 110-1 and AP 110-2 correspond to the AP 110-1 and AP 110-2 as depicted in FIG. 3A, respectively. AP 110-1 and AP 110-2 belong to the same SMD and are controlled by a backend infrastructure (e.g., WLC 115 of FIG. 3A).

In this embodiment, IEEE 802.11bi EDP is enforced, and a shared PTK is used across APs within the SMD. Unlike the embodiment shown in FIG. 6, where the DS MAC address is used as the reference identifier and included in the roaming request, in this embodiment, the DS MAC address is withheld from the roaming request to avoid exposure to potential OTA interception. Instead, one of the next ERM addresses is included in the roaming request, and the serving AP 110-1 shares a TA-DS MAC mapping (e.g., 330 of FIG. 3A) with target APs to support correct PTK retrieval. This approach improves privacy and security because the persistent identifiers, like the DS MAC address, are not transmitted in the cleartext during roaming events.

Under the 802.11bi EDP framework, the DS MAC address of STA 105-1, its current ERM, and a list of next ERM addresses may be provided either in the encrypted portion of the association request 805 or as part of the 4-way handshake process, such as within the EAPOL M2 (820) or M4 (840).

As depicted, the initial association process begins when STA 105-1 sends an association request 805 to AP 110-1. The association request may be encrypted (e.g., using a PMK derived from a prior SAE) and include the STA's 105-1 DS MAC address, its current ERM address, and a list of next ERM addresses. AP 110-1 accepts the requests and replies with an association response 810. The 4-way handshake is then performed, including: M1 (815), sent from AP 110-1 to STA 105-1, including an ANonce; M2 (820), sent from STA 105-1 to AP 110-1, including a SNonce; M3 (825), sent from AP 110-1 to STA 105-1, including a MIC confirming integrity of the PTK and optionally a GTK; and M4 (830), sent from AP 110-1 to STA 105-1, including a MIC confirming PTK installation, and, in some embodiments, may also carry the STA's 105-1 DS MAC address, current ERM address, and a list of next ERM addresses.

After PTK 1 is established, AP 110-1 generates two mappings: a TA-DS MAC mapping (e.g., 330 of FIG. 3A) that links the ERM address (including both current and next ERM addresses) to the STA's 105-1 DS MAC address; and a DS MAC-PTK mapping (e.g., 335 of FIG. 3A) that links the STA's 105-1 DS MAC address to the established PTK 1. These mappings are then shared with other APs in the SMD, either directly or via a WLC (e.g., 115 of FIG. 3A), as shown by the mapping sharing message 835.

When STA 105-1 roams to AP 110-2, the STA sends a roaming request 840 to the target AP. The request 840 is PMF-protected using PTK 1 and includes one of the next ERM addresses as the TA.

Upon receiving the request 840, AP 110-2 uses the ERM address to look up the associated DS MAC address (e.g., via the shared TA-DS MAC mapping). AP 110-2 then retrieves PTK 1 using the DS MAC-PTK mapping and decrypts the request. Upon successful verification and confirmation that all roaming criteria are met (e.g., sufficient resources are available for admission, policy requirements are met), AP 110-1 sends a roaming response 845 back to STA 105-1, approving the handover and completing the roaming securely and seamlessly.

In embodiments where the list of next ERM addresses initially provided during the association has been exhausted or has expired, the serving AP (e.g., AP 110-2 during a later association) may receive a new set of ERM addresses from the STA, either as part of a subsequent roaming request or another protected management frame. Upon receiving the updated ERM list, the serving AP may update the TA-DS MAC mapping accordingly and then propagate the updated mapping to other APs in the domain.

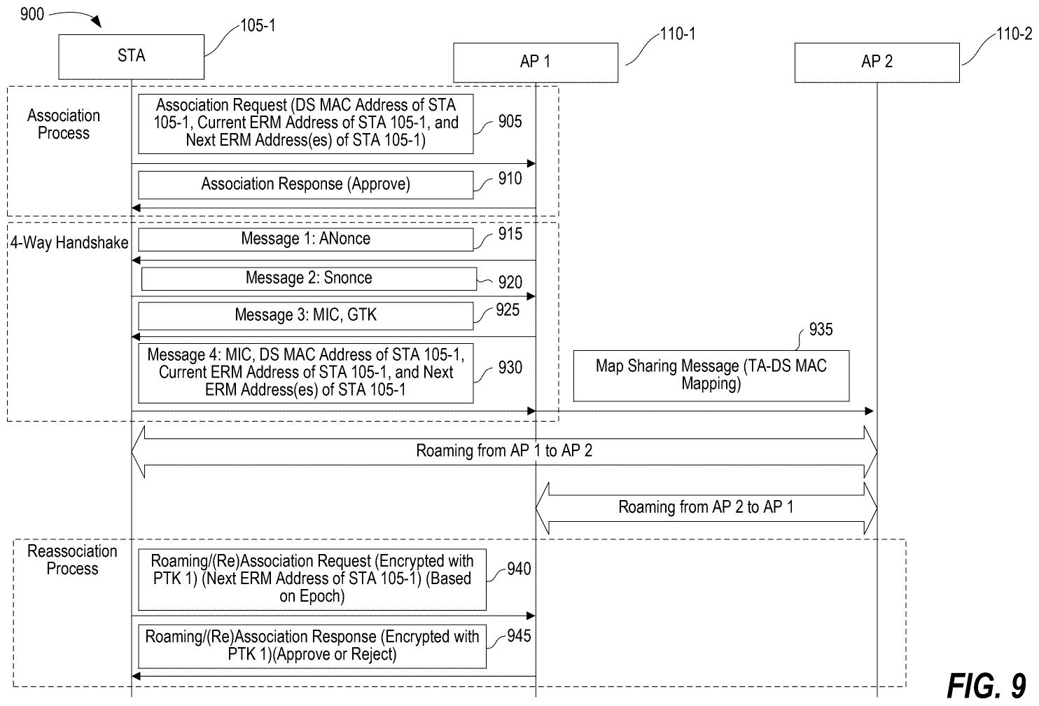

FIG. 9 depicts an example sequence of interactions 900 between a STA 105-1 and two APs 110-1 and 110-2, where the STA 105-1 roams between the two APs using AP-specific PTKs and a roaming request includes a next ERM address for STA recognition by a target AP, according to some embodiments of the present disclosure.

The STA 105-1 corresponds to the STA 105-1 as depicted in FIG. 3B. The AP 110-1 and AP 110-2 correspond to the AP 110-1 and AP 110-2 as depicted in FIG. 3B, respectively. AP 110-1 and AP 110-2 belong to the same SMD and are controlled by a backend infrastructure (e.g., WLC 115 of FIG. 3B).

In this embodiment, IEEE 802.11bi EDP is enforced, and AP-specific PTKs are used across APs within the SMD. The DS MAC address of STA 105-1, its current ERM, and a list of next ERM addresses may be provided either in the encrypted portion of the association request 905 or with a protected EAPOL M2 or M4 as part of the 4-way handshake. The next ERM address, instead of the DS MAC address, is later included in the roaming request to serve as a reference identifier for PTK retrieval. This approach ensures that the DS MAC address remains protected and is not exposed OTA.

The association process is initiated by STA 105-1 sending an association request 905 to the target AP 110-1. The association request 905 may be encrypted using a PMK (e.g., derived from a prior SEA). The request may include the STA's 105-1 DS MAC address, its current ERM address, and a list of the next ERM addresses the STA intends to use in upcoming epochs. Upon accepting the association, AP 110-1 responds with an association response 910, and the 4-way handshake proceeds. As depicted, four messages are exchanged, including: M1 (915), sent from AP 110-1 to STA 105-1, including an ANonce; M2 (920), sent from STA 105-1 to AP 110-1, including a SNonce; M3 (825), sent from AP 110-1 to STA 105-1, including a MIC and optionally the GTK; and M4 (830), sent from STA 105-1 to AP 110-1, which includes a MIC confirming successful PTK installation, and, in some embodiments, may also carry the STA's DS MAC, its current ERM, and a list of next ERM addresses.

After the handshake completes, PTK 1 is established between STA 105-1 and AP 110-1. AP 110-1 generates two mappings, including a TA-DS MAC mapping that associates each ERM (e.g., current and next ERM addresses) with the STA's 105-1 DS MAC address, and a DS MAC-PTK mapping that links the DS MAC address to the established PTK 1.

Because PTK 1 is AP specific (which is only used for communication between STA 105-1 and AP 110-1), it is not shared with other APs in the domain. AP 110-1 only shares the TA-DS MAC mapping with other APs, either directly or via a WLC, to support STA recognition in future roaming events.

At a later time, as depicted, STA 105-1 roams to AP 110-2, which does not have a PTK established with STA 105-1. Therefore, a full 4-way handshake is performed to establish a new PTK 2. Subsequently, when STA 105-1 decides to roam back to AP 110-1 (e.g., due to improved RSSI or reentering AP's 110-1 coverage), STA 105-1 initiates a handover by sending a roaming request 940 to AP 110-1. The roaming request is encrypted using PTK 1 and includes one of the previously provided next ERM addresses (e.g., ERM₃). The included next ERM address corresponds to the active EDP epoch during the roaming event. Upon receiving the request 940, AP 110-1 uses the ERM (e.g., ERM₃) to retrieve the corresponding DS MAC address via its locally stored TA-DS MAC mapping. Then, using the DS MAC address, AP 110-1 retrieves PTK 1, decrypts the request, and verifies its integrity and authenticity. If all roaming criteria are met, AP 110-1 sends a roaming response 945 back to STA 105-1, approving the reassociation request and completing the handover.

In embodiments where the list of next ERM addresses initially provided during the association has been exhausted or has expired, the current serving AP (e.g., AP 110-1 or AP 110-2) may receive a new set of ERM addresses from the STA. Upon receiving the updated ERM list, the serving AP may update its TA-DS MAC mapping accordingly and then share the updated mapping to other APs in the domain.

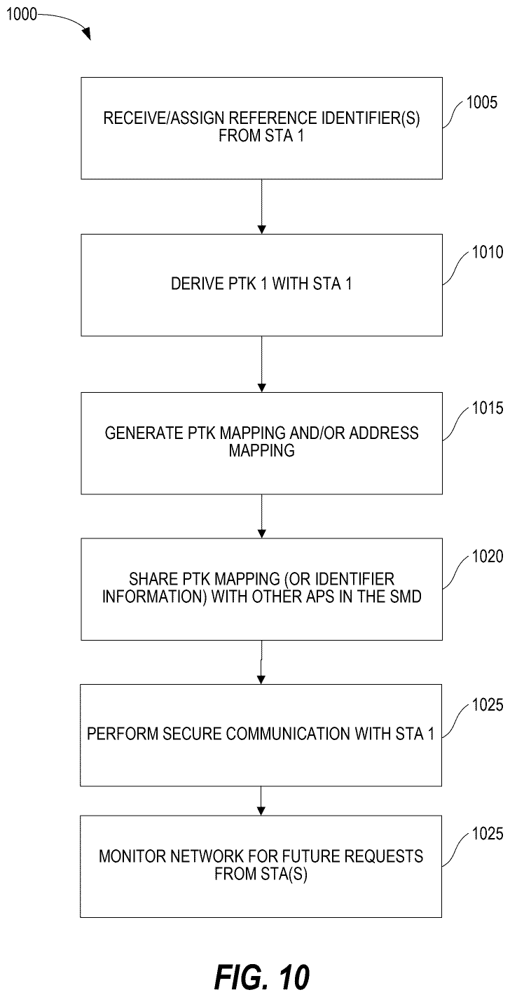

FIG. 10 depicts an example method 1000 performed by a serving AP (AP 1) during the initial association, including establishing PTKs and sharing the STA's identifier information with other APs in the same SMD, according to some embodiments of the present disclosure. The serving AP that performs the example method 1000 may either be a single-link AP or multi-link AP, such as AP 110-1 as depicted in FIGS. 1A-1B, 2A-2B, and 3A-3B.

At block 1005, the serving AP (also referred to as AP 1) receives or assigns reference identifier(s) from a STA (e.g., 105-1 as depicted in FIGS. 1A-1B, 2A-2B, and 3A-3B) (also referred to as STA 1). The reference identifier(s) may later be used to retrieve the correct PTK during roaming. When IEEE 802.11bh is enforced, the IRM address or Device ID may be used as the reference identifier. When an IRM address is used, the IRM address may be provided by the STA as part of the association request frame or EAPOL M2 or M4. When Device ID is used, the Device ID may be assigned by the AP 110-1 at block 1005 and delivered in the association response frame or EAPOL M3. When IEEE 802.11bi EDP is used, where the STA's MAC address is periodically randomized across epoch boundaries, the STA's DS MAC address may be used as the reference identifier for PTK retrieval, and an ERM may be defined and used for roaming recognition. In this configuration, STA 105-1 may provide its DS MAC address, the current ERM address, and a list of next ERM addresses either in the encrypted portion of the association request or in an EAP exchange message during the 4-way handshake (e.g., M2 or M4).

At block 1010, the serving AP (AP 1) derives PTK 1 based on received inputs, including the ANonce generated by the serving AP, the SNonce provided by the STA 1, the PMK derived during a previous authentication exchange (e.g., SAE), and the MAC addresses of the AP 1 and STA 1.

Once the PTK is confirmed (e.g., following the reception of M4 from the STA), at block 1015, the serving AP (AP 1) generates mapping(s) that link PTK 1 to the appropriate reference identifier. When the IRM address or Device ID is used (802.11bh), a single mapping is created that associates the IRM address or Device ID with PTK 1 (as depicted in FIGS. 1A-1B). When 802.11bi EDP is used, the ERM addresses rotate across epochs or defined time intervals. If the DS MAC address is included directly in the roaming request (as depicted in FIGS. 2A-2B), a single mapping is created that associates the DS MAC address to PTK 1. If the DS MAC address is withheld from the roaming request and the STA instead uses one of the next ERM addresses (as depicted in FIGS. 3A-3B), two mappings are generated, including a TA-DS MAC mapping that maps each ERM to the STA's DS MAC, and a DS MAC-PTK mapping that links the DS MAC address to PTK 1.

At block 1020, the AP 1 shares mapping or identifier data with other APs in the same SMD. In embodiments where a shared PTK approach is adopted (e.g., where the PTK 1 established between the STA 1 and the AP 1 can be reused by other APs in the same SMDs), the serving AP shares the full mapping either directly with peer APs or via a WLC. The shared mapping may include a TA-PTK mapping, which links a Device ID, IRM address, ERM address, or DS MAC address directly to the PTK, or a combination of TA-DS MAC mapping and DS-PTK mapping, when the DS MAC is used as an indirect identifier. If an AP-specific PTK approach is adopted (e.g., where the PTK is unique to the AP that established it), only the reference identifier information is shared with other APs. This may include the STA's IRM or Device ID (as defined in 802.11bh), or a TA-DS MAC mapping (e.g., which maps each ERM address to the STA's DS MAC address). The sharing of mapping or identifier data allows other APs to recognize the STA during future roaming events.

At block 1025, with PTK 1 installed, the serving AP (AP 1) and the STA 1 begin secure communication using PMF encrypted with PTK 1.

At block 1030, the serving AP (AP 1) monitors the network for subsequent roaming requests from STA 1 as well as other STAs attempting to roam in or reassociate. When a roaming request arrives containing a known reference identifier (e.g., an IRM, Device ID, DS MAC address, or one of the next ERM addresses), AP 1 looks up its previously created mappings to retrieve the corresponding PTK and facilitate a secure and seamless handover without a full reauthentication exchange.

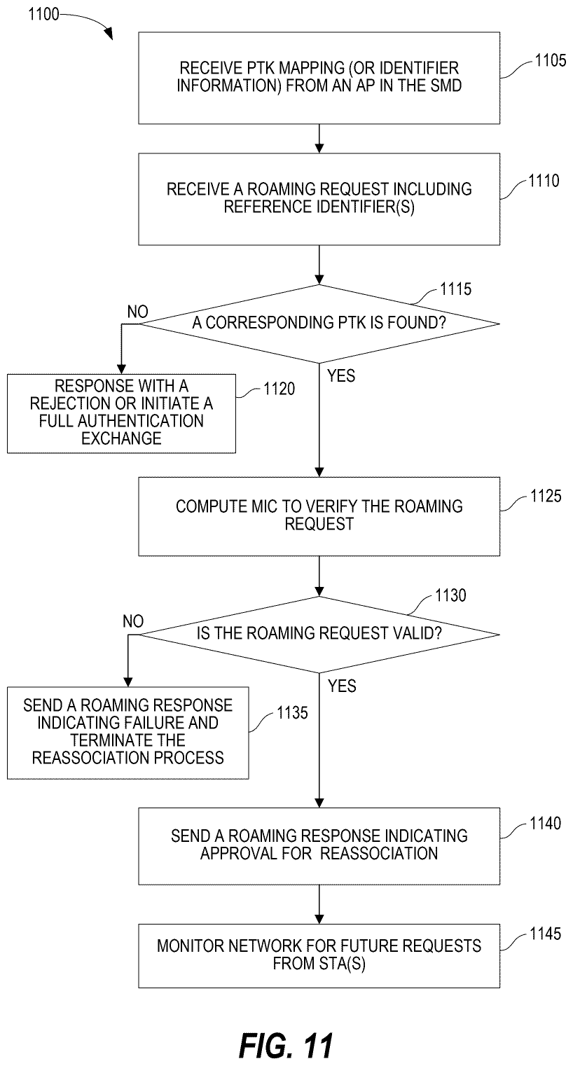

FIG. 11 depicts an example method 1100 performed by a target AP (AP 2) in response to a roaming request from a STA (STA 1), according to some embodiments of the present disclosure. The target AP that performs the example method 1100 may either be a single-link AP or multi-link AP, such as AP 110-2 as depicted in FIGS. 1A-1B, 2A-2B, and 3A-3B.

At block 1105, the target AP (also referred to as AP 2 hereinafter) receives PTK mapping (e.g., TA-PTK mappings, or a combination of TA-DS MAC mapping and DS MAC-TPK mapping) or reference identifier information (e.g., STA's IRM address, Device ID, ERM address, or DS MAC address) for a STA (also referred to as STA 1 hereinafter) (e.g., 105-1 of FIGS. 1A-1B, 2A-2B, and 3A-3B). The STA is currently associated with AP 1 (e.g., AP 110-1 of FIGS. 1A-1B, 2A-2B, and 3A-3B). The mapping or reference information is received either directly from the AP 1 or via a WLC (e.g., 115 of FIGS. 1A-1B, 2A-2B, and 3A-3B). With the received data, the AP 2 updates its local cache to reflect the new or revised mappings, preparing it to recognize the STA 1 in future roaming requests.

At block 1110, the AP 2 receives a roaming request from the STA 1. The roaming request includes one or more reference identifiers in the TA field. When IEEE 802.11bh is used, the roaming request may include either the STA's Device ID or IRM address as the reference identifier for PTK lookup. When IEEE 802.11bi EDP is used and the DS MAC address serves as the reference identifier, the DS MAC address may be included directly in the roaming request (e.g., in the TA field). In embodiments with improved privacy, the DS MAC address is withheld, and the roaming request includes one of the next ERM addresses (originally provided during association with AP 1). The ERM address corresponds to the current EDP epoch and serves as an indirect reference that the target AP can map to the DS MAC address to retrieve the associated PTK.

At block 1115, the AP 2 searches its local cache or queries a centralized source (e.g., WLC 115 of FIGS. 1A-1B, 2A-2B, and 3A-3B) using the reference identifier to retrieve the corresponding PTK. If no matching PTK is found, the method moves to block 1120.

The absence of a matching PTK may indicate either a signaling error (e.g., when a shared PTK approach is adopted) or a legitimate first-time association (e.g., when a per-AP PTK approach is used). In a shared PTK model, the absence of a matching PTK may signal an error or signaling gap, since the PTK established between STA 1 and AP 1 is expected to be reused by other APs within the SMD. In such configurations, the target AP (AP 2) may respond with a rejection, and the STA 1 may retry the roaming request or fall back to initiating a new association. When a per-AP PTK configuration is adopted, the lack of a matching PTK may simply indicate that the target AP is a new AP the STA has not previously associated with. In this configuration, the AP may prompt the STA to initiate a full authentication process, such as a new SAE and/or EAPOL exchange, to establish a new PTK (e.g., PTK 2).

If, at block 1115, a corresponding PTK is found, the method proceeds to block 1125. Using the retrieved PTK (e.g., PTK 1), the AP 2 attempts to decrypt the roaming request and compute a MIC based on the message content. At block 1130, the AP 2 determines whether the received roaming request is valid and sent from a legitimate entity. In this embodiment, the AP computes the MIC using the retrieved PTK and compares it to the MIC included in the roaming request. If the computed MIC matches the received MIC, this indicates that the STA 1 possesses the correct PTK and the message has not been compromised or tampered with. The method 1100 proceeds to 1140, where the AP 2 approves the reassociation and sends a response to enable secure and seamless handover.

If the MIC does not match, this may indicate that STA 1 does not possess the correct PTK, which could imply a potential man-in-the-middle (MiTM) attack or that STA 1 is otherwise untrusted or unauthenticated. In this case, the method 1100 moves to block 1135, where the AP 2 sends a rejection response denying the reassociation. The STA 1 may choose to retry the roaming request at a later time or fall back to initiating a full authentication exchange.

Once the reassociation is approved at block 1140, the method 1100 proceeds to block 1145, where AP 2 and STA 1 engage in secured communication using the retrieved PTK. The PTK may be used to protect data and management frames exchanged between the AP 2 and STA 1. Following successful handover, AP 2 continues to monitor the network for any future roaming or connection requests, either from the same STA or from other STAs. AP 2 may then apply previously cached mappings and facilitate seamless roaming when applicable.

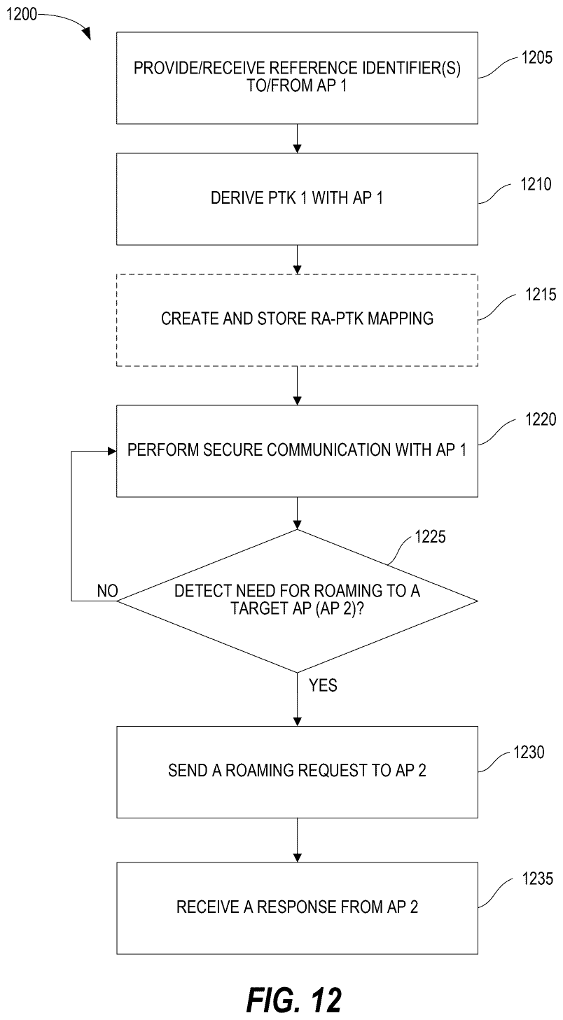

FIG. 12 depicts an example method 1200 performed by a STA (STA 1), beginning with an initial association to AP 1 and proceeding to a roaming event with AP 2, according to some embodiments of the present disclosure. The STA (STA 1) that performs the example method 1200 may either be a single-link device or a multi-link device, such as STA 105-1 as depicted in FIGS. 1A-1B, 2A-2B, and 3A-3B.

At block 1205, STA 1 provides or receives reference identifier(s) to/from AP 1 (e.g., AP 110-1 of FIGS. 1A-1B, 2A-2B, and 3A-3B) during the initial association process. The reference identifier(s) may later be used for recognizing the STA 1 and retrieving the corresponding PTK during future roaming events. In an IEEE 802.11bh-enabled framework, the reference identifier may be an IRM, which is provided by the STA 1 as part of the association request frame or EAPOL M4. In another embodiment, Device ID may be used as the identifier, which is assigned by the AP 1 and returned to the STA in the association response frame or EAPOL M3. In embodiments compliant with the IEEE 802.11 EDP framework, during the initial association process, the STA 1 may provide AP 1 information, including a DS MAC address, along with its current ERM address, and a list of next ERM addresses that it intends to use across EPD epochs. These identifiers may be conveyed either in the encrypted portion of the association request frame or within a protected EAPOL message (e.g., M2 or M4). In this configuration, the DS MAC address may serve as the primary reference identifier for PTK retrieval.

At block 1210, the STA 1 participates in the 4-way handshake and derives a PTK 1 with AP 1, using the exchanged nonces, the PMK, and the MAC address of the STA 1 and AP 1.

In embodiments where the AP-specific PTK is used (e.g., where the PTK established with one AP is not shared with other APs in the SMD), STA 1 needs to track which PTK corresponds to which AP. As depicted, at block 1215, the STA 1 may generate a RA-PTK mapping, which links the MAC address of the serving AP (e.g., AP 1) to the derived PTK 1. The mapping may be saved locally by the STA and later used to determine the correct PTK to apply when roaming back to a previously associated AP.

With PTK 1 established, as depicted at block 1220, STA 1 engages in secured communication with AP 1 using PMF frames encrypted under PTK 1. At block 1225, STA 1 actively monitors network conditions (e.g., RSSI, frame loss rate, or other mobility-related metrics) to determine whether a roaming event is needed to a target AP. As used herein, the target AP is within the same SMD as the original serving AP. If no roaming is needed, the method loops back to block 1220 for continuous monitoring. If roaming is triggered, the method 1200 proceeds to block 1230, where STA 1 initiates the roaming process.

At block 1215, STA 1 sends a roaming request to AP 2, the target AP. The request may include a reference identifier, such as an IRM or Device ID under the IEEE 802.11bh framework, or the DS MAC address of STA 1 or one of its next ERM addresses under the IEEE 802.11bi EDP framework. With the provided reference identifier, AP 2 can recognize STA 1 and retrieve the corresponding PTK 1 without requiring a full reauthentication exchange.

In embodiments where a shared PTK model is used, the STA 1 may simply encrypt the roaming request using PTK 1, assuming that AP 2 has access to the PTK 1 via shared mappings. In embodiments where a per-AP PTK mode is adopted, the STA 1 may check its local RA-PTK mapping to determine whether a PTK had previously been established with AP 2. If no PTK is found, the STA 1 may send the roaming request unencrypted or protected using a default key, and subsequently perform a full authentication process once association is accepted by AP 2. If a matching PTK (e.g., PTK 2) is found, the STA 1 may encrypt the roaming request using that specific PTK.

At block 1235, after transmitting the roaming request, STA 1 receives a response from AP 2, which either approves or rejects the reassociation request. If the AP 2 cannot admit the STA 1 due to insufficient resources or policy conditions not being met, the roaming request may be rejected. In contrast, the request may be approved if the AP 2 successfully verifies the reference identifier, retrieves or establishes a valid PTK, and confirms that roaming criteria and system constraints are satisfied. Once the roaming request is approved, STA 1 and AP 2 begin secure communication using the established PTK (whether it was retrieved from a prior session or newly derived through a full handshake). In some embodiments, the STA 1 may also update its local RA-PTK mapping if a new PTK was established.

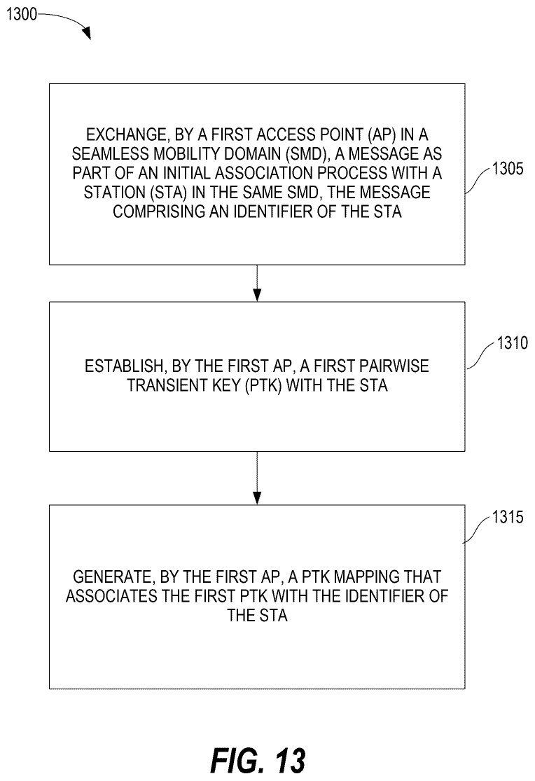

FIG. 13 is a flow diagram depicting an example method 1300 performed by a serving AP for handling an initial association from a STA and generating a PTK mapping that associates the STA's identifier with an established PTK, according to some embodiments of the present disclosure.

At block 1305, a first access point (AP) (e.g., AP 110-1 of FIGS. 1A-1B, 2A-2B, and 3A-3B) in a seamless mobility domain (SMD) exchanges a message (e.g., EAPOL message or an association request) as part of an initial association process with a station (STA) (e.g., STA 105-1 of FIGS. 1A-1B, 2A-2B, and 3A-3B) in the same SMD, the message comprising an identifier (e.g., IRM or Device ID under the 802.11bh framework, or DS MAC under the 802.11bi EDP framework) of the STA.

At block 1310, the first AP establishes a first pairwise transient key (PTK) (e.g., PTK 1) with the STA.

At block 1315, the first AP generates a PTK mapping that associates the first PTK (e.g., PTK 1) with the identifier (e.g., IRM or Device ID under the 802.11bh framework, or DS MAC under the 802.11bi EDP framework) of the STA.

In some embodiments, the identifier may comprise an Identifiable Random Media Access Control (MAC) (IRM) address provided by the STA to the first AP, and the message comprises an association request or a Message 2 (M2) or a Message 4 (M4) exchanged as part of a 4-way handshake.

In some embodiments, the identifier may comprise a Device Identifier (ID), and the message comprises an association response or a Message 1 (M1) or a Message 3 (M3) exchanged as part of a 4-way handshake.

In some embodiments, the first PTK may be specific to communication between the first AP and the STA, and the first AP may further share the identifier with at least one of one or more second APs in the SMD or a wireless controller in the SMD.

In some embodiments, the first PTK may be shared with one or more second APs in the SMD, and the first AP may further share the PTK mapping with at least one of the one or more second APs or a wireless controller in the SMD.

In some embodiments, a second AP (e.g., AP 110-2 of FIGS. 1A-1B, 2A-2B, and 3A-3B) in the same SMD may be configured to receive a roaming request from the STA, the roaming request comprising the identifier in a transmitter address (TA) field, identify the STA based on the identifier, retrieve the PTK associated with the identifier using the shared PTK mapping from the first AP, and decrypt the roaming request using the PTK.

In some embodiments, a second AP in the SMD may be configured to receive a roaming request from the STA, the roaming request comprising the identifier in a transmitter address (TA) field, establish a new PTK with the STA, and generate a second PTK mapping that associates the new PTK with the identifier of the STA.

In some embodiments, the identifier may comprise a Distribution System (DS) Media Access Control (MAC) address of the STA, and DS MAC address may be provided by the STA in an encrypted portion of an association request.

In some embodiments, the first AP may further generate an address mapping that associates the DS MAC address of the STA with at least one of a current Enhanced Data Privacy (EDP) Random Media Access Control (MAC) (ERM) address of the STA or one or more next ERM addresses to be used by the STA in one or more subsequent epochs. In some embodiments, the first PTK may be shared among one or more second APs in the SMD, and the first AP may share the PTK mapping and the address mapping with at least one of the one or more second APs or a wireless controller in the SMD.

In some embodiments, the first PTK may be specific to communication between the first AP and the STA, and the first AP may share with at least one of one or more second APs or a wireless controller in the same SMD, information comprising at least one of the DS MAC address of the STA, the current ERM address of the STA, or the one or more next ERM addresses.

In some embodiments, a second AP may be configured to receive a roaming request from the STA, the roaming request comprising one of the next ERM addresses in a transmitter address (TA) field, recognize the STA by mapping the next ERM address in the TA field to the DS MAC address of the STA using the shared address mapping from the first AP, retrieve the PTK associated with the DS MAC address of the STA using the shared PTK mapping from the first AP, and decrypt the roaming request using the PTK.

In some embodiments, the second AP may be configured to receive a roaming request from the STA, the roaming request comprising one of the next ERM addresses in a transmitter address (TA) field, establish a new PTK with the STA, generate a second PTK mapping that associates the new PTK with the DS MAC address of the STA, and generate a second address mapping that associates the DS MAC address of the STA with the one or more next ERM addresses.

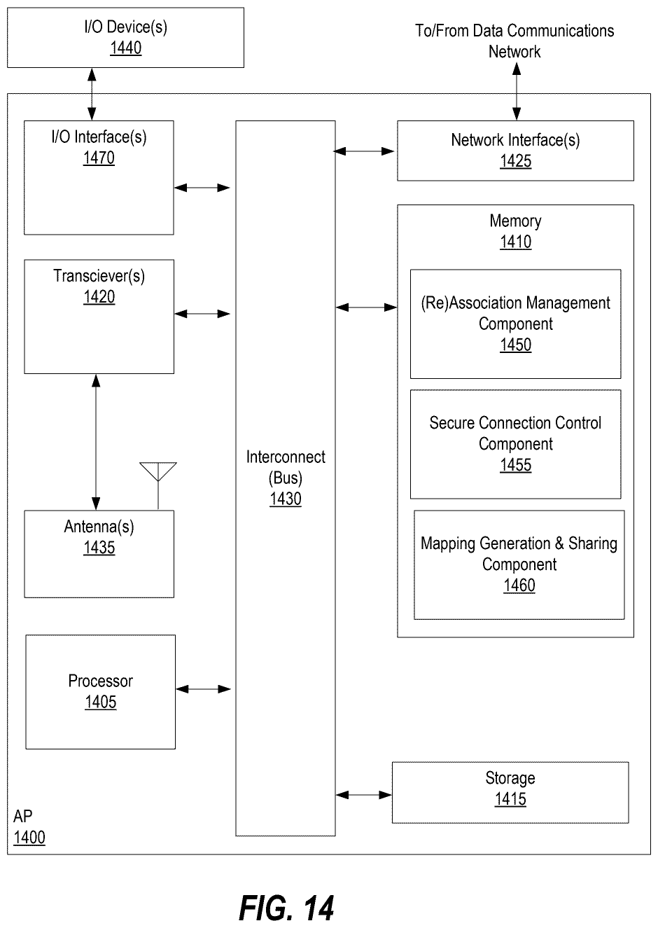

FIG. 14 depicts an example network device configured to perform various aspects of the present disclosure, according to some aspects of the present disclosure.

In some embodiments, the example network device 1400 may be an AP or any other type of network device (e.g., a router, switch, or network controller) that is capable of supporting the described functionality. In some embodiments, the example network device 1400 may correspond to APs 110 as depicted in FIGS. 1A-1B, 2A-2B, and 3A-3B.

As illustrated, the example network device 1400 includes a processor 1405, memory 1410, storage 1415, one or more transceivers 1420, one or more I/O interfaces 1480, and one or more network interfaces 1425. In some embodiments, I/O devices 1440 are connected via the I/O interface(s) 1480. Further, via the network interface 1425, the network device 1400 can be communicatively coupled with one or more other devices and components (e.g., via a network, which may include the Internet, local network(s), and the like). Each of the components is communicatively coupled by one or more buses 1430. In some embodiments, one or more antennas 1435 may be coupled to the transceivers 1420 for transmitting and receiving wireless signals.

The processor 1405 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1405 processes information received through the transceiver 1420, I/O interfaces 1480, and the network interfaces 1425. The processor 1405 retrieves and executes programming instructions stored in memory 1410, as well as stores and retrieves application data residing in storage 1415.

The storage 1415 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1415 may store a variety of data for the efficient functioning of the system.

The memory 1410 may include random access memory (RAM) and read-only memory (ROM). The memory 1410 may store processor-executable software code containing instructions that, when executed by the processor 1405, enable the network device 1400 to perform various functions described herein for wireless communication. In the illustrated example, the memory 1410 includes three software components: the (re) association management component 1450, the secure connection control component 1455, and the mapping generation & sharing component 1460.

In one embodiment, the (re) association management component 1450 manages the initial association process and any subsequent reassociation requests from STAs attempting to roam to the network device 1400. Upon receiving a request, the component 1450 parses the request to extract the reference identifier (e.g., an IRM or Device ID under the IEEE 802.11bh framework, or a DS MAC address or one of the next ERM addresses under the IEEE 802.11bi EDP framework), queries the local cache or a WLC for a matching PTK, and determines whether the STA is authorized to association.

In one embodiment, the secure connection control component 1455 is configured to manage the 4-way handshake process to establish a PTK between the network device 1400 and a STA. In one embodiment, the PTK generated may be shared with other APs in the SMD via a WLC or direct AP-to-AP communication. When the STA roams from AP 1 to AP 2, the new AP can retrieve the same PTK without requiring a full reauthentication process. In some embodiments, each AP generates its own PTK independently. Since AP 2 does not receive PTK 1 from AP 1, it cannot decrypt the roaming request unless a new handshake is completed. In this configuration, STA is required to maintain a PTK mapping table, tracking which PTK corresponds to each AP it has associated with.

In one embodiment, the mapping generation and sharing component 1460 is configured to generate and maintain PTK mappings, and in some embodiments, share these mappings with other APs in the SMD. When the 4-way handshake completes, the component 1460 creates a mapping that associates the STA's identifier (e.g., IRM address, Device ID) with the generated PTK. In embodiments where the DS MAC address is used, the component 1460 may generate an address mapping that associates each provided ERM (e.g., current and next ERM addresses) with the DS MAC address, as well as a PTK mapping that links the PTK DS MAC address to the established PTK.

Although depicted as a discrete component for conceptual clarity, in some embodiments, the operations of the depicted components (and others not illustrated) may be combined or distributed across any number of components. Further, although depicted as software residing in memory 1410, in some aspects, the operations of the depicted components (and others not illustrated) may be implemented using hardware, software, or a combination of hardware and software.

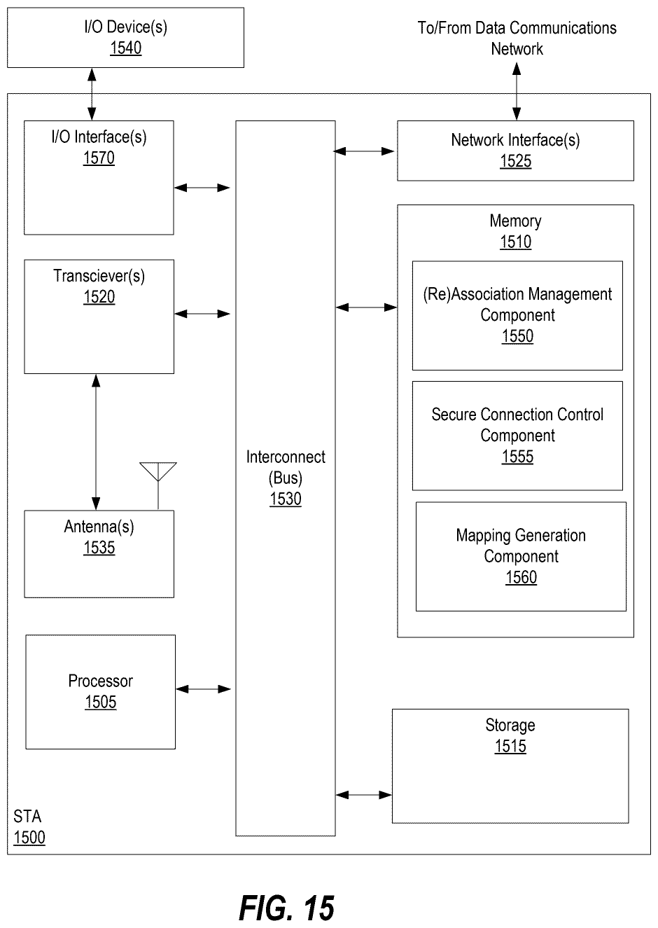

FIG. 15 depicts an example client device 1500 configured to perform various aspects of the present disclosure, according to some aspects of the present disclosure.

In some embodiments, the example client device 1500 may correspond to STA 105-1 as depicted in FIGS. 1A-1B, 2A-2B, and 3A-3B. Examples of client devices include smartphones, laptops, IoT devices, or any other wireless computing device that supports seamless roaming within an SMD.

As illustrated, the example client device 1500 includes a processor 1505, memory 1510, storage 1515, one or more transceivers 1520, one or more I/O interfaces 1580, and one or more network interfaces 1525. In some embodiments, I/O devices 1540 are connected via the I/O interface(s) 1580. Further, via the network interface 1525, the client device 1500 can be communicatively coupled with one or more other devices and components (e.g., via a network, which may include the Internet, local network(s), and the like). Each of the components is communicatively coupled by one or more buses 1530. In some embodiments, one or more antennas 1535 may be coupled to the transceivers 1520 for transmitting and receiving wireless signals.

The processor 1505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1505 processes information received through the transceiver 1520, I/O interfaces 1580, and the network interfaces 1525. The processor 1505 retrieves and executes programming instructions stored in memory 1510, as well as stores and retrieves application data residing in storage 1515.

The storage 1515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1515 may store a variety of data for the efficient functioning of the system.

The memory 1510 may include random access memory (RAM) and read-only memory (ROM). The memory 1510 may store processor-executable software code containing instructions that, when executed by the processor 1505, enable the client device 1500 to perform various functions described herein for wireless communication. In the illustrated example, the memory 1510 includes three software components: the (re) association management component 1550, the secure connection control component 1555, and the mapping generation component 1560.

In one embodiment, the (re) association management component 1550 is designed to manage the initial association and roaming processes, including monitoring network conditions to determine when roaming is desired. During the initial association, the component 1550 generates and sends an association request to an AP (e.g., AP 110-1 of FIG. 1A-1B, 2A-2B, or 3A-3B). The request includes the reference identifier (e.g., an IRM or Device ID under the IEEE 802.11bh framework, or a DS MAC address or one of the next ERM addresses under the IEEE 802.11bi EDP framework). If the AP approves the association, the component 1550 proceeds to secure connection setup. The component 1550 further monitors network conditions (e.g., RSSI, latency, packet loss) to determine when roaming is needed. When roaming is initiated, the component 1550 generates and transmits a roaming request to a target AP. The roaming request may be PMF-protected using the established PTK and includes the reference identifier(s) of the STA (e.g., an IRM or Device ID under the IEEE 802.11bh framework, or a DS MAC address or one of the next ERM addresses under the IEEE 802.11bi EDP framework) to maintain secure and seamless authentication at the target AP.

In one embodiment, the secure connection control component 1555 performs the 4-way handshake with an AP to establish a PTK for encrypted communication. The component 1555 may also oversee encryption and protection of frames using PMFF during active connections.

In one embodiment, the mapping generation component 1560 generates and maintains a per-AP PTK (also referred to as the RA-PTK mapping) mapping for managing PTK association with different APs. The component 1560 stores the PTK and its corresponding AP MAC address in a local cache table. When roaming, the component 1560 checks the cache to retrieve the correct PTK for the target AP before encrypting the roaming request.

Although depicted as a discrete component for conceptual clarity, in some embodiments, the operations of the depicted components (and others not illustrated) may be combined or distributed across any number of components. Further, although depicted as software residing in memory 1510, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
exchanging, by a first access point (AP) in a seamless mobility domain (SMD), a message as part of an initial association process with a station (STA) in the SMD, the message comprising an identifier of the STA;
establishing, by the first AP, a first pairwise transient key (PTK) with the STA; and
generating, by the first AP, a PTK mapping that associates the first PTK with the identifier of the STA.

2. The method of claim 1, wherein the identifier comprises an Identifiable Random Media Access Control (MAC) (IRM) address provided by the STA to the first AP, and the message comprises an association request or a Message 2 (M2) or a Message 4 (M4) exchanged as part of a 4-way handshake.

3. The method of claim 1, wherein the identifier comprises a Device Identifier (ID), and the message comprises an association response or a Message 1 (M1) or a Message 3 (M3) exchanged as part of a 4-way handshake.

4. The method of claim 1, wherein the first PTK is specific to communication between the first AP and the STA, and the method further comprises:
sharing, by the first AP, the identifier with at least one of one or more second APs in the SMD or a wireless controller in the SMD.

5. The method of claim 1, wherein the first PTK is shared with one or more second APs in the SMD, and the method further comprises:
sharing, by the first AP, the PTK mapping with at least one of the one or more second APs or a wireless controller in the SMD.

6. The method of claim 5, wherein a second AP in the same SMD is configured to:
receives a roaming request from the STA, the roaming request comprising the identifier in a transmitter address (TA) field;
identify the STA based on the identifier;
retrieve the PTK associated with the identifier using the shared PTK mapping from the first AP; and
decrypt the roaming request using the PTK.

7. The method of claim 4, wherein a second AP in the SMD is configured to:
receive a roaming request from the STA, the roaming request comprising the identifier in a transmitter address (TA) field;
establish a new PTK with the STA; and
generate a second PTK mapping that associates the new PTK with the identifier of the STA.

8. The method of claim 1, wherein the identifier comprises a Distribution System (DS) Media Access Control (MAC) address of the STA, and the DS MAC address is provided by the STA in an encrypted portion of an association request.

9. The method of claim 8, further comprising:
generating an address mapping that associates the DS MAC address of the STA with at least one of a current Enhanced Data Privacy (EDP) Random Media Access Control (MAC) (ERM) address of the STA or one or more next ERM addresses to be used by the STA in one or more subsequent epochs.

10. The method of claim 9, wherein the first PTK is shared among one or more second APs in the SMD, and the method further comprises:
sharing, by the first AP, the PTK mapping and the address mapping with at least one of the one or more second APs or a wireless controller in the SMD.

11. The method of claim 9, wherein the first PTK is specific to communication between the first AP and the STA, and the method further comprises:
sharing, by the first AP with at least one of one or more second APs or a wireless controller in the same SMD, information comprising at least one of the DS MAC address of the STA, the current ERM address of the STA, or the one or more next ERM addresses.

12. The method of claim 10, wherein a second AP is configured to:
receive a roaming request from the STA, the roaming request comprising one of the next ERM addresses in a transmitter address (TA) field;
recognize the STA by mapping the next ERM address in the TA field to the DS MAC address of the STA using the shared address mapping from the first AP;
retrieve the PTK associated with the DS MAC address of the STA using the shared PTK mapping from the first AP; and
decrypt the roaming request using the PTK.

13. The method of claim 11, wherein a second AP is configured to:
receive a roaming request from the STA, the roaming request comprising one of the next ERM addresses in a transmitter address (TA) field;
establish a new PTK with the STA;
generate a second PTK mapping that associates the new PTK with the DS MAC address of the STA; and
generate a second address mapping that associates the DS MAC address of the STA with the one or more next ERM addresses.

14. A system of a first access point (AP), comprising:
one or more computer processors; and
one or more memories collectively containing one or more programs, which, when executed by the one or more computer processors, perform an operation, the operation comprising:
exchanging, by a first access point (AP) in a seamless mobility domain (SMD), a message as part of an initial association process with a station (STA) in the SMD, the message comprising an identifier of the STA;
establishing, by the first AP, a first pairwise transient key (PTK) with the STA; and
generating, by the first AP, a PTK mapping that associates the first PTK with the identifier of the STA.

15. The system of claim 14, wherein the identifier comprises an Identifiable Random Media Access Control (MAC) (IRM) address provided by the STA to the first AP, and the message comprises an association request or a Message 2 (M2) or a Message 4 (M4) exchanged as part of a 4-way handshake.

16. The system of claim 14, wherein the identifier comprises a Device Identifier (ID), and the message comprises an association response or a Message 1 (M1) or a Message 3 (M3) exchanged as part of a 4-way handshake.

17. The system of claim 14, wherein the PTK is specific to communication between the first AP and the STA, and the operation further comprises:
sharing, by the first AP, the identifier with at least one of one or more second APs in the SMD or a wireless controller in the SMD.

18. The system of claim 14, wherein the PTK is shared with one or more second APs in the SMD, and the operation further comprises:
sharing, by the first AP, the PTK mapping with at least one of the one or more second APs or a wireless controller in the SMD.

19. The system of claim 18, wherein a second AP in the same SMD is configured to:
receives a roaming request from the STA, the roaming request comprising the identifier in a transmitter address (TA) field;
identify the STA based on the identifier;
retrieve the PTK associated with the identifier using the shared PTK mapping from the first AP; and
decrypt the roaming request using the PTK.

20. One or more non-transitory computer-readable media containing, in any combination, computer program code that, when executed by operation of a computer system, performs an operation comprising:
exchanging, by a first access point (AP) in a seamless mobility domain (SMD), a message as part of an initial association process with a station (STA) in the SMD, the message comprising an identifier of the STA;
establishing, by the first AP, a first pairwise transient key (PTK) with the STA; and
generating, by the first AP, a PTK mapping that associates the first PTK with the identifier of the STA.
